(19) United States
(12) Patent Application Publication
(10) Pub. No.: US 2005/0067828 A1
(43) Pub. Date: Mar. 31, 2005

(54) Load cell and seat occupant weight sensing system

(76) Inventor: Peter Norton, Farmington, MI (US)

Correspondence Address: Peter Norton, Post Office Box 62, Northville, MI, 48167, US

(21) Appl. No.: 10/991,619

(22) Filed: Nov. 18, 2004

Related U.S. Application Data
(63) Continuation-in-part of application No. 10/104,556, filed on Mar. 22, 2002, now Pat. No. 6,820,896.
Application No. 10/104,556 is a continuation-in-part of application No. 09/495,212, filed on Jan. 31, 2000, now abandoned.
Application No. 09/495,212 is a continuation-in-part of application No. 09/289,048, filed on Apr. 9, 1999, now Pat. No. 6,364,352.
Application No. 09/289,048 is a continuation-in-part of application No. 09/081,194, filed on May 19, 1998, now Pat. No. 6,224,094.
Application No. 09/289,048 is a continuation-in-part of application No. 09/112,727, filed on Jul. 9, 1998, now Pat. No. 6,259,167.

(51) Int. Cl. B60R 21/32

(52) U.S. Cl. 280/806

(57) ABSTRACT

Four load cells supporting a seat or part thereof provide four signals that are added to determine the weight of the seat occupant. Each load cell has two flanged springs stressed to provide preload. The two springs operate in concert to resist side forces and moments, making the load cell responsive to both compressive and tensile forces while being substantially unresponsive to lateral forces and moments tending to cause angular misalignment between input elements. A preferred load cell has a liquid filled chamber and a pressure sensor providing an electric signal indicating the pressure in the liquid, which is related to the applied force. Preferred manufacturing methods make the cost low. A seat belt tension sensor may close a switch at a predetermined seat belt tension or may measure the seat belt tension. A preferred mounting limits side forces to the load cells.

This is a continuation-in-part of application Ser. No. 10/104,556 filed Mar. 22, 2002 and titled SEAT OCCUPANT WEIGHT SENSING SYSTEM, which is a continuation-in-part of application Ser. No. 09/495,212 filed Jan. 31, 2000 and titled SEAT OCCUPANT WEIGHT SENSING SYSTEM, now abandoned, which is a continuation-in-part of application Ser. No. 09/289,048 filed Apr. 9, 1999 and titled SEAT OCCUPANT WEIGHT SENSING SYSTEM which is a continuation-in-part of application Ser. No. 09/081,194 filed May 19, 1998 and titled FORCE SENSOR FOR SEAT OCCUPANT WEIGHT SENSOR now issued as U.S. Pat. No. 6,224,094. Application Ser. No. 09/289,048 is also a continuation-in-part of application Ser. No. 09/112,727 filed Jul. 7, 1998 and titled SEAT OCCUPANT WEIGHT SENSING SYSTEM now issued as U.S. Pat. No. 6,259,167.

### FIELD OF THE INVENTION

This invention relates to systems that ascertain what is occupying a vehicle seat to assist in determining optimum airbag deployment.

### BACKGROUND OF THE INVENTION

Airbags of occupant protection systems are expensive and in certain circumstances are dangerous. It is, therefore, worthwhile to prevent deploying an airbag into an empty seat to save repair cost. It is important to avoid deployment when circumstances do not warrant deployment or when deployment might do more harm than good. It is particularly important to deploy the airbag judiciously when the seat is occupied by a child or by a very small adult. Current law requires an occupant sensing system to reliably distinguish a 107-pound adult from a child.

Occupant protection systems typically include a “sensor and diagnostic module” or “SDM” that performs functions related to sensing the severity of a vehicle crash, monitoring various components of the occupant protection system for proper operation, and initiating deployment of occupant protection means. SDMs typically include a microprocessor, an accelerometer, an arming sensor, circuitry interconnecting the aforementioned components and switches for initiating deployment of the occupant protection devices. SDMs may be connected to receive input from such as side mounted and forward mounted crash sensors.

Knowledge of the weight of a seat occupant is useful. If the weight is very small it may be assumed that the seat is unoccupied or occupied by a small child; in either case airbag deployment would not be desired. If the weight is intermediate, say between 30 and 45 kilograms, then the occupant is likely to be a child and the airbag should be deployed gently if at all. If the weight is greater than 45 kilograms the seat occupant is likely to be an adult who would be protected by an airbag.

Three types of weight sensing systems for vehicle seats are in current production: A first type of weight sensing system comprises an array of force sensors located immediately beneath the upholstery material of the seat cushion, which operates to measure the pressure of the occupant against the seat at the points where sensors are located. These sensors are typically responsive to small forces applied over a small area and an array of force sensors tells a microprocessor the magnitude and distribution of the force the occupant applies to the cushion. The microprocessor ascertains the weight and other attributes of the seat occupant from the information provided by the array of force sensors.

The second type of weight sensing system includes a fluid filled “bladder” located between the foam of the seat cushion and a pan. A pressure sensor measures the pressure in the bladder and the pressure reading is used to classify the seat occupant by weight category.

The third type of weight sensing system comprises sensors for sensing stress in structural members of the seat. A chair having a load cell at each leg for sensing the weight carried by the leg with an adder for adding the inputs from each load cell would be an example of the third type of weight sensing system. The outputs of the sensors (four load cells in the case of the aforementioned chair) are added and the weight of the empty seat is subtracted to obtain the weight of the occupant.

Load cells comprising a piston sealingly movable in a cylinder to generate hydraulic pressure are well known. At the front of a reclined seat the seat may apply upward force to a load cell, which requires a load cell that responds to both tension and compression. To measure tension, a sensor based on a piston sealingly movable in a tube must be preloaded by such as a spring to maintain a pressure in the liquid, that pressure diminishing when tension is applied. The output of load cells preloaded by springs may vary with temperature because liquids typically have larger thermal expansion coefficients than metals. Relative expansion of the liquid with temperature changes the preload with temperature. A gel may be used in place of the liquid because it is easier to seal against leakage.

The aforementioned need for temperature compensation and other needs such as compensation for nonlinear pressure response and variable overall span are often met by including an inexpensive microprocessor or an “application specific integrated circuit” (ASIC), which is a purpose built microprocessor, typically located in close proximity to the pressure sensor where it can sense the temperature of the pressure sensor.

In load cells comprising a piston movable in a liquid filled cylinder there is friction between the piston and the cylinder under non-axial or side forces. Side forces have many causes: Mounting the load cell between the seat and the floor can cause side forces from differential thermal expansion between the car floor and the seat, stresses from attaching the seat to the vehicle, damage to the seat or the car floor, and forces resulting from acceleration of the vehicle or actions of the seat occupant. This requires protecting the piston from angular misalignment between seat parts and car floor parts caused by production variations in the parts. A load cell is needed that is inherently insensitive to side forces and angular misalignments.

Seat occupant weight sensing systems responsive to stress in the seat structure must respond only to forces resulting from the weight of the seat occupant and not to stresses resulting from thermal expansion or attachment to the vehicle. An advantage of seat occupant weight sensing systems responsive to stress in the seat structure is that the seat belt can be attached to the seat above the weight sensor where seat belt tension for retaining a child seat does not affect the weight measurement. Anchoring the seat belts to the seat frame and placing the force sensors between the belt anchors and the vehicle attachment points makes the measured weights independent of seat belt forces and makes a seat belt tension sensor unnecessary.

One location for four load cells is between the vehicle floor and the seat. Substantial forces can occur between a seat and the vehicle floor. For example, if a structural member of a seat is attached to the floor of a vehicle it can happen that the structural member remains at a temperature comfortable to the vehicle occupants while the vehicle floor goes from a very cold temperature caused by winter conditions to a very high temperature caused by heat rising from a catalytic converter. Thermal expansion of the floor can cause substantial horizontal stresses on load cells placed between the floor of a vehicle and the seat.

Semiconductor pressure sensors are manufactured in large quantities by micro machining silicon wafers. Designs are based on various technologies and physical principles. These sensors may require additional components to meet needs for such as temperature compensation. An ASIC offers one way to meet those needs. Certain micro machined sensors operate immersed in the liquid the pressure of which they are sensing.

Many force sensors based on strain gauge technology are commercially available. Ceramic disks to which strain gauge elements are attached provide an electric signal responsive to force applied between the center of the disk and the perimeter of the disk. It is also well known to apply strain gauge elements to stressed components of a structure to measure the stress and, thereby, to measure the force being received by the structure.

Load cells of the type that convert force to hydraulic pressure are less expensive to make if they include absolute pressure sensors rather than gauge pressure sensors because the micro machined sensors themselves are less expensive and because absolute pressure sensors simplify the design of the load cell because it is not necessary to provide a duct from the pressure sensor to the outside atmosphere. The output of a force sensor comprising an absolute pressure sensor responds to changes in atmospheric pressure. Going from sea level to an altitude of 5,300 feet at Denver, Colo. with the same occupant weight can cause an apparent three to ten pound decrease in the force sensed by each load cell, which must be corrected if the measurement is to be accurate.

It is well known to connect a sensor by only two electrical conductors. In typical designs the sensor simultaneously draws power needed to operate and also draws constant or pulsed current over and above the current it requires to operate. The additional current indicates the physical measurement.

U.S. Pat. No. 6,259,167 issued to the present inventor describes a seat occupant weight sensing system based on torque sensed at the cushion of a seat and two seat occupant weight sensing systems responsive to torque at the seat frame.

U.S. Pat. No. 6,259,167 also discloses a force sensor comprising a liquid filled injection stretch blow molded bottle having bellows shaped sides and a pressure sensor thereby being a force sensor responsive to axial force. The force sensor operates by converting axial force to pressure in the liquid for sensing by the pressure sensor. This patent is included herein by reference.

U.S. Pat. No. 6,224,094 issued to the present inventor describes a load cell for generating an electric signal indicating applied force. The load cell has a pressure sensor and a means for converting applied force to pressure whereby its output becomes a force signal. The load cell is preloaded by a constant force spring whereby relative thermal expansion between the liquid and the structural parts of the load cell does not cause the pressure in the liquid to vary. The spring also provides a low friction bearing for axial movement and resists radial movement between two parts of the load cell. This patent is included herein by reference.

Weight sensing systems comprising a platform supported by load cells are well known. For example, U.S. Pat. No. 4,056,156 issued to Arnold J. Dayton on Nov. 1, 1977 teaches a bathroom scale having four load cells each having a resilient metal bellows for pressurizing liquid and connected to a common plenum connected to a pressure sensor. These weight sensing systems can be quite sensitive to temperature if the bellows have a large spring constant unless provision is made to accommodate the change of volume of the liquid with temperature. One exception is if the liquid is water at room temperature because water has a very low thermal expansion coefficient between 5° C. and 25° C. For vehicle occupant weight sensing, accurate response is required between −40° C. and +100° C. and for this operating temperature range all known suitable liquids exhibit large thermal expansions relative to metals and most plastics.

A general object of this invention is to provide a seat occupant weight sensing system offering low cost and superior performance and a load cell for use in the system, which also overcomes certain disadvantages of the prior art.

### SUMMARY OF THE INVENTION

In accordance with preferred embodiments of the invention, a seat occupant weight sensing system comprises load cells adapted to receive and be responsive to the force the seat occupant applies to the seat. Each load cell comprises two force input members and a pair of springs that operate in concert to enable the load cell to accurately measure axial force while enabling the load cell to be unresponsive to moments and forces applied perpendicular to the axis.

Further, in accordance with preferred embodiments of the invention, the two springs when unstressed are slightly conical springs unitary with cylindrical flanges at their inside and the outside diameters. The cone angle is preferably such that preloading the springs during load cell manufacture flattens the springs to make them substantially flat rather than cone shaped. The spring flanges are affixed or linked to the force input members. The springs allow frictionless axial movement of the force input members relative to each other while resisting radial movement between the force input members relative to each other.

Further, in accordance with the certain embodiments of the invention, the two springs resist axial misalignment between the force input members. This is advantageous when the load cell is located between the seat and the vehicle floor because the load cell compels the part of the vehicle floor where the seat is attached and the part of the seat that is attached to the vehicle floor to be parallel to each other, which makes the stresses on the seat and the floor similar to stresses that occur when the seat is bolted directly to the vehicle floor as it would be if there were no load cells.

Further, in accordance with a preferred embodiment of the invention, the mounting between the load cell and a component to which the load cell is mounted is adapted to yield in a sideways direction when subjected to a modest side force such as fifty pounds. The yielding limits the side force applied to the load cell to approximately fifty pounds. The ability to yield eases the requirements for insensitivity to side forces relative to a load cell that might have to withstand the substantial side forces, which might result from such as relative thermal expansion between two vehicle components between which a load cell is attached.

Further, in accordance with preferred embodiments of the invention, the load cell comprises means for converting force applied to the force input members to pressure in a liquid and a pressure sensor providing an electric signal indicating the hydraulic pressure.

Further, in accordance with certain preferred embodiments of the load cell of the invention, precise control of the volume containing the liquid is inexpensively achieved by performing a weld that positions a spring relative to a force input member while the spring and the force input member are held against each other. This enables the metal parts of the load cell to be made by processes such as stamping and forging to specified tolerances easily achieved by those processes.

Further, in accordance with certain preferred embodiments of the load cell of the invention wherein a liquid has a much larger thermal expansion coefficient than materials of which the other parts of the load cell are made; the difference in thermal expansion coefficients between the liquid and the other parts is compensated by using designs and materials that provide partial or complete compensation that reduces or eliminates the variation of the output of the load cell with temperature. It advantageously happens that the materials that compensate for different thermal expansion are also particularly desirable materials for the functions they perform in the load cell.

Further, in accordance with preferred embodiments of the invention, a part made of a metal having a larger thermal expansion coefficient than the other metal parts is provided between a force input member and a spring for causing relative movement therebetween, thereby compensating for temperature.

Further, in accordance with the aforementioned preferred embodiments of the invention, the material having a larger thermal expansion coefficient than the other metal parts expands as temperature increases to increase the volume available for the liquid.

Further, in accordance with the aforementioned preferred embodiments of the invention, the material having a larger thermal expansion coefficient has the form of an outer sleeve. The expansion of the sleeve relative to the other metal parts causes both a relative movement between a spring and a force input member and also causes an increase in the volume available for the aforementioned liquid by expanding radially outward to provide additional space for the fluid adjacent to the inner surface of the sleeve.

Further, in accordance with certain preferred embodiments of the load cell of the invention, a force input member is attached to a vehicle seat or the vehicle structure by a threaded fastener and isolation means are provided to isolate stresses caused by tightening the threaded fastener from components adjacent the liquid and thereby minimize the effect of the stress on the output of the load cell.

Further, in accordance with certain embodiments of the load cell of the invention, a force sensor comprising a liquid filled injection stretch blow molded bottle having bellows shaped sides and a pressure sensor is adapted to receive force from the force input members and provide an electric signal responsive to the applied axial force.

Further, in accordance with certain embodiments of the load cell of the invention a commercially available force sensor is positioned to receive force from the force input members whereby it provides an electric signal responsive to the applied axial force.

Further, in accordance with certain embodiments of the load cell of the invention strain gauge elements are applied to components of the load cell to respond to strain induced by axial force received by the force input members whereby it provides an electric signal responsive to the applied axial force.

Further, in accordance with preferred embodiments of the invention each load cell is tested after it is made and numbers determined from the performance of the load cell are stored in the load cell.

Further, in accordance with certain preferred embodiments of the invention in which numbers are stored in the load cell, those numbers are stored in a semiconductor memory in the load cell.

Further, in accordance with certain preferred embodiments of the invention in which numbers are stored in a semiconductor memory in the load cell, the semiconductor memory is unitary with the pressure sensor.

Further, in accordance with certain preferred embodiments of the invention in which numbers are stored in the load cell, those numbers are stored by etching markings indicating the numbers onto the surface of the load cell where they can be read and entered into a common calculating component when the load cells and the common calculating component are assembled into a vehicle seat.

Further, in accordance with a preferred embodiment of the invention comprising a multiplicity of load cells, each load cell receives some of the weight to be measured. The load cells are connected with a common calculating component that adds the weights indicated by the load cells and calculates the total weight of the seat occupant.

Further, in accordance with a preferred embodiment of the invention comprising a multiplicity of load cells, each load cell is made without an internal calculator for calculating compensation for the effect of temperature and is connected with a common calculating component that receives output signals from each load cell and calculates compensation for temperature for each of the load cells.

Further, in accordance with preferred embodiments of the invention in which numbers are stored in the load cell, those numbers are provided to a common calculating component, which it uses to correct the force signals received from each of the load cells for temperature variations.

Further, in accordance with preferred embodiments of the invention comprising an absolute pressure sensor, atmospheric pressure is measured and used to correct the outputs of the load cells for variations in atmospheric pressure.

Further, in accordance with the preferred embodiments of the invention comprising a common calculating component that calculates temperature compensation for a multiplicity of load cells, each load cell includes the aforementioned part made of a metal having a larger thermal expansion coefficient than the other metal parts for compensating for temperature. In this design the larger part or preponderance of the temperature compensation results from thermal expansion of the metal part made of a metal having a larger thermal expansion coefficient than the other metal parts. The common calculating component operates to make small corrections that might be required if the temperature compensation caused by the metal with a larger thermal expansion coefficient than the other metal parts is not as precise as required. This design is advantageous in applications wherein more accurate thermal compensation is required because it saves the cost of a temperature sensor in the load cell because the temperature at the common calculating component is sufficiently accurate for making the small corrections.

Further, in accordance with certain preferred embodiments of the invention, a switch responsive to seat belt tension is provided that closes at a predetermined tension that would be uncomfortable to a human and therefore indicates that the seat is being occupied by a tightly belted child seat.

Further, in accordance with certain preferred embodiments of the invention, a sensor is provided for indicating seat belt tension. It is particularly useful for indicating a predetermined tension that would be uncomfortable to a human and, therefore, indicates that the seat is being occupied by a tightly belted child seat.

Further, in accordance with certain preferred embodiments of the invention, a seat belt tension sensor comprises two bowed bands adapted to straighten when stressed by seat belt tension. A sensor responds to the straightening of the two bands. An extension from the seat belt applies tension to the bands and protects against torques that might tend to unevenly stress the bowed steel bands. A microprocessor uses the tension to calculate the weight of the seat occupant in the presence or absence of substantial seat belt tension.

Further, in accordance with certain embodiments of the invention, the seat belt tension is combined with other information to calculate the weight of the seat occupant when the seat belt tension is contributing to the force the seat occupant applies to the seat.

A complete understanding of this invention may be obtained from the description that follows taken with the accompanying drawings.

### DESCRIPTION OF THE DRAWINGS

FIG. 1 shows a perspective view of a vehicle seat with the first embodiment of the seat occupant weight sensing system of the invention with certain components related to weight sensing indicated by dashed lines.

FIG. 2 shows a side view of the seat illustrated in FIG. 1 and also shows a seat belt tension sensor.

FIG. 3 shows partially in section a preferred load cell of the invention.

FIG. 4 shows an isometric view of the base component of the load cell illustrated in FIG. 3.

FIG. 5 shows an isometric exploded view of the top component of the load cell illustrated in FIG. 3.

FIG. 6 shows an isometric view of a cover that will become a part of the top component of the load cell illustrated in FIGS. 3 and 5.

FIG. 7 shows an isometric view of the upper spring of the load cell illustrated in FIG. 3, and showing a section.

FIG. 8 shows an isometric view of the lower spring of the load cell illustrated in FIG. 3, and showing a section.

FIG. 9 shows an isometric view of the sleeve of the load cell illustrated in FIG. 3, and showing a section.

FIG. 10 shows partially in section the load cell illustrated by FIG. 3 and also illustrates spring flexing and a preferred method of attachment.

FIG. 11 shows a sensor responsive to seat belt tension comprising a pair of bowed bands and a distance sensor.

FIG. 12 shows the sensor illustrated in FIG. 11 as it appears when seat belt tension is being applied.

FIG. 13 shows a sensor responsive to seat belt tension comprising a pair of bowed bands and a force sensor.

FIG. 14 shows an alternate load cell comprising a discrete force sensor adapted to receive force from a base and a force transmitter.

### BEST MODE FOR CARRYING OUT THE INVENTION

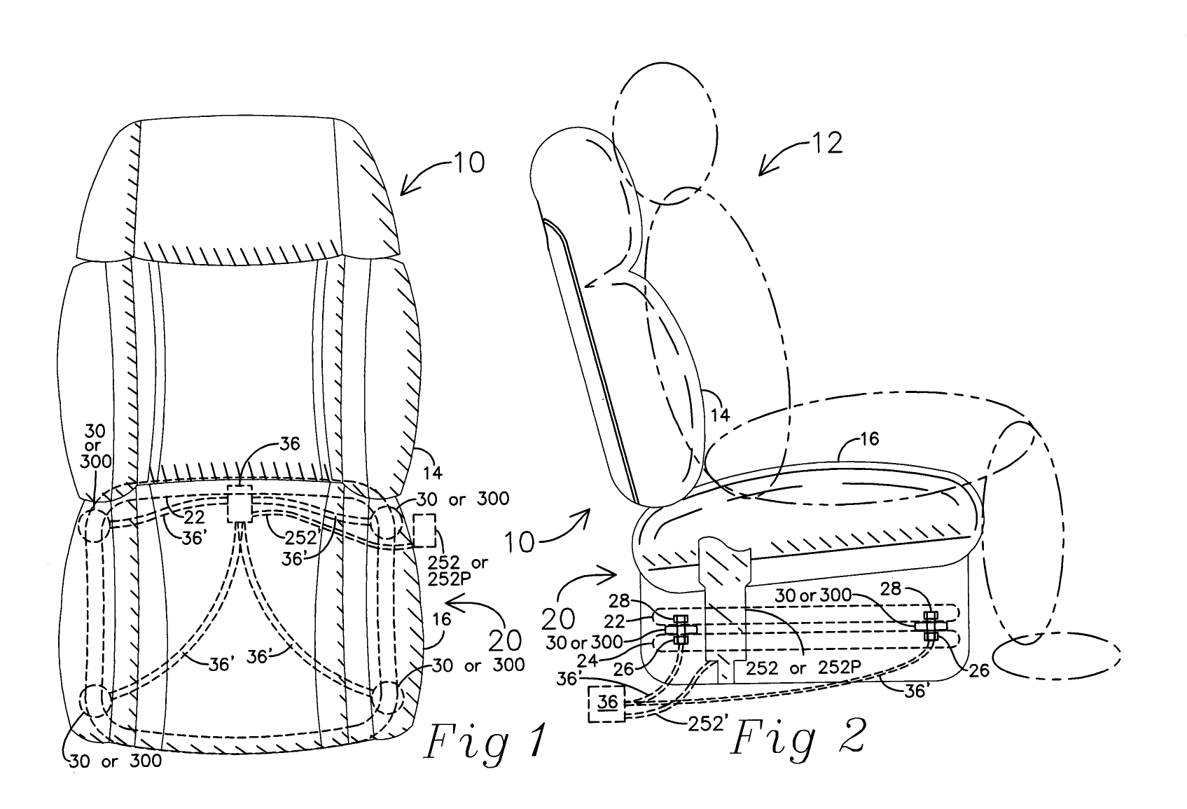

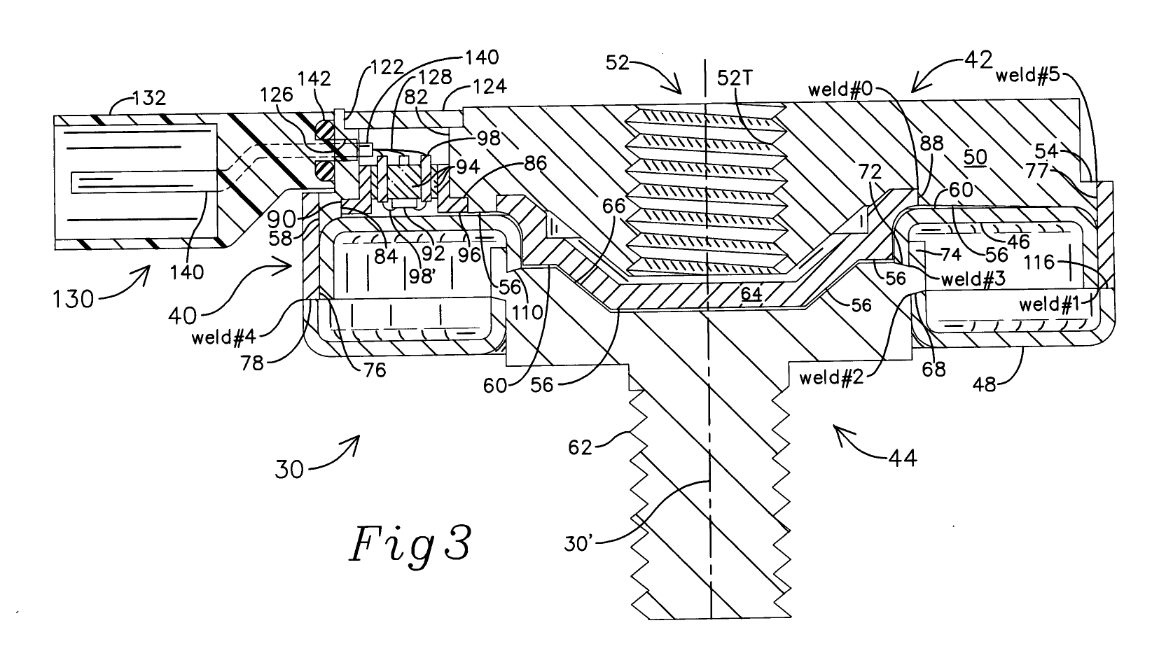

Proceeding first with reference to FIGS. 1 through 3, vehicle seat 10 is equipped with an occupant weight sensing system 20 for weighing the seat occupant. In FIGS. 1 and 2 the occupant weight sensing components are illustrated with hidden lines. Occupant weight sensing system 20 comprises four load cells 30 connected to a processing unit 36 that adds the outputs of the four load cells 30 and generates an electric signal indicating the weight applied to the seat. Occupant weight sensing system 20 may also comprise a seat belt tension sensor 252 or 252P. The seat 10 receives weight from the seat occupant through cushion 16 and seat back 14. The weight is transferred to an upper member 22 of the seat frame. The upper frame member 22 applies downward force to the load cells 30 located between the upper seat frame member 22 and a lower seat frame member 24. Alternately, the load cells 30 may be located between the seat and vehicle floor (not illustrated). The load cells respond to downward force between upper frame member 22 and lower frame member 24 by generating electric signals. Processing unit 36 may include a microprocessor and may include an atmospheric pressure sensor. Processing unit 36 may be combined with an SDM into one package where it shares a microprocessor with the SDM. The electrical connections between the combined SDM and processing unit 36 and other parts of the vehicle are not illustrated. If processing unit 36 and the SDM are not unitary then an electrical connection (not illustrated) is provided for transmitting information from processing unit 36 to the SDM. It will be appreciated as the description proceeds that the invention may be implemented in different embodiments.

The description of occupant weight sensing system 20 is now continued with reference to FIGS. 1 through 3 and 10 but without, for now, a detailed description of seat belt tension sensors 262 or 262P. Seat occupant weight sensing system 20 when it includes a seat belt tension sensor 262 or 262P is described hereinafter.

Seat occupant weight sensing system 20 comprises upper frame member 22 for supporting seat back 14 and seat cushion 16. The upper frame comprising upper frame member 22 may be any design known to be suitable by those skilled in the relevant arts. Any of the known upper frame designs of the type that are attached to a lower frame by four bolts with axes oriented approximately in the vertical direction and located near the corners of the seat as illustrated are likely to be adaptable for load cells. Many such designs are currently in volume production. The lower frame comprising lower frame member 24 may be any design known to be suitable by those skilled in the relevant arts. Any of the known lower frame designs compatible with a suitable upper frame are likely to be adaptable for load cells. Other materials and manufacturing methods suitable for frame members 22 and 24 may be substituted by those skilled in the relevant arts.

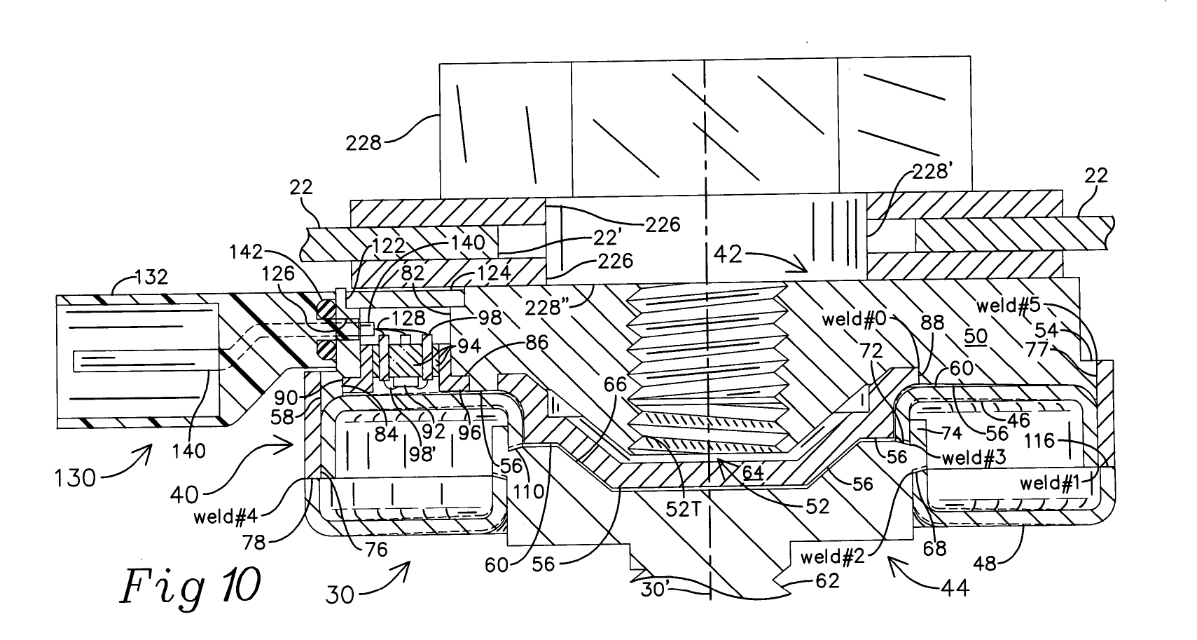

Alternately, load cell 30 may be attached to a seat frame member 22 as illustrated in FIG. 10 by a shoulder bolt 228 having an unthreaded portion 228′ and a bolt shoulder 228″. Shoulder bolt 228 retains upper frame member 22 between two washers 226. Washers 226 are preferably Belleville springs compressed to flatness. A flat Belleville spring provides a predetermined compression force that assures slippage at a predictable side force. Seat frame member 22 has an opening 22′ that is substantially larger than the unthreaded portion 228′ of shoulder bolt 228 to allow limited relative movement between seat frame member 22 and shoulder bolt 228 to relieve stresses from relative thermal expansion and contraction.

Each load cell 30 provides an electrical signal through an electrical cable 36′ to processing unit 36 indicating the axial force applied to the load cell 30. Each load cell 30 is attached by a threaded nut 26 to lower frame member 24 and by a bolt 28 to upper frame member 22.

Load cells 30 may be located at any other location known to be suitable by those skilled in the relevant arts. In particular, it is desirable for certain vehicles and seat designs to place load cells 30 between the seat and the vehicle floor in place of bolts attaching the seat to the vehicle floor.

Proceeding now with particular reference to FIG. 3, load cell 30 comprises sleeve 40, top 42, base 44, upper spring 46, lower spring 48, and pressure sensor assembly 90. Load cell 30 is filled with liquid 60.

Referring now to FIGS. 3 and 9, sleeve 40 is preferably a tubular component comprising surfaces 76, 77, and 78 for welding to the outer flange of spring 46, the outside diameter of flange 54 of top 42, and the outer flange of spring 48 respectively. The material selected for sleeve 40 affects how load cell 30 responds at different temperatures. The variation of the output of load cell 30 with temperature is minimized by the thermal expansion coefficients of the metals selected for sleeve 40, top 42, base 44, and springs 46 and 48; and the amount of and the thermal expansion coefficient of liquid 60.

If sleeve 40 is made of a material having a larger thermal expansion coefficient than top 42, base 44, upper spring 46, and lower spring 48 it can partially or totally compensate for the relatively large thermal expansion coefficient of liquid 60. A suitable material for sleeve 40 is type 304 stainless steel. Type 304 stainless steel in one design provided full temperature compensation. Sleeve 40 is preferably made by cutting a section from commercial stainless steel tubing using such as a Haven Ringmaster (Ringmaster is a trademark of the Haven Corporation of Brunswick, Ga.) and stretching it slightly by passing a ball through it to accurately size the inner surface 76 and 77. Surface 78 may be trued to assure laser welding will produce a high quality weld at weld #4. Sleeve 40 has an inside diameter sufficiently larger than the outside diameter of spring 46 to assure there will be clearance at the lowest operating temperatures while keeping the gap small enough for welding with a laser welder. A radial gap of 0.002″ (0.005 mm) is easily achieved and meets the aforementioned requirements. Alternately and preferably, the outside diameter of the outer flange of upper spring 46 may be enlarged at the end where weld #1 is performed to reduce the gap prior to weld #1 to zero or less for a slight interference fit. Other materials and processes for making sleeve 40 may be substituted by those skilled in the relevant arts.

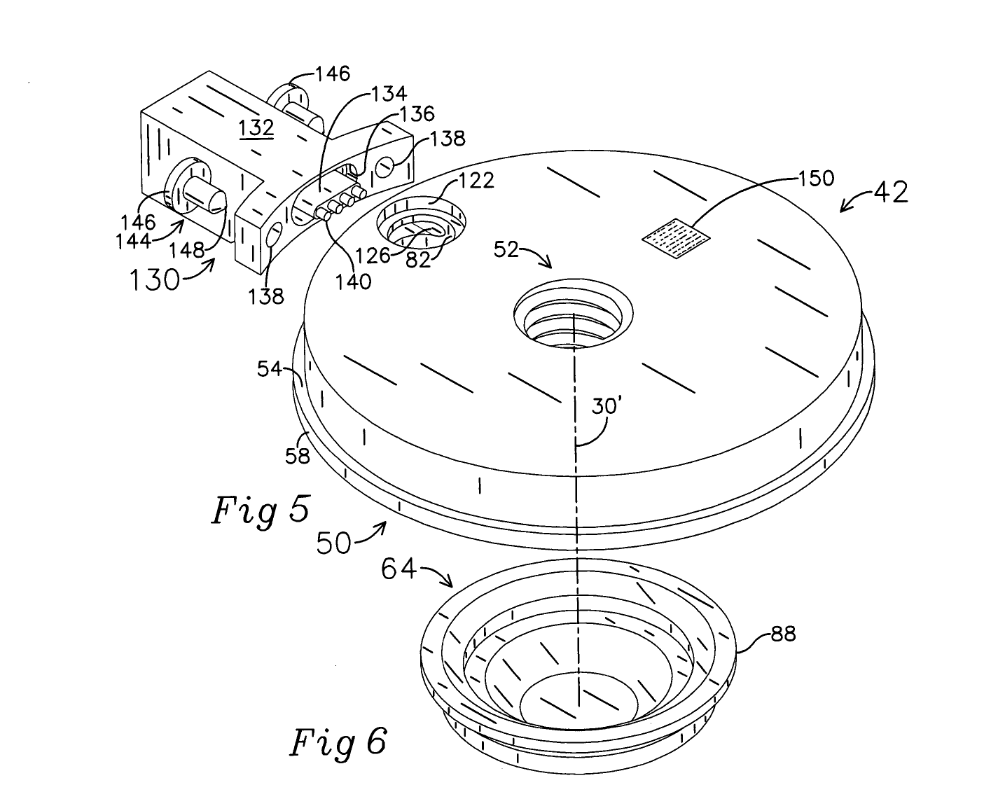

Proceeding now with particular reference to FIGS. 3, 5, and 6; top 42 of load cell 30 preferably comprises a disk 50, a cover 64 for threaded opening 52, a pressure sensor assembly 90 (illustrated in FIG. 3), a pressure sensor assembly cover 124 (illustrated in FIG. 3), a connector 130, and data 150. Other designs for top 42 may be substituted by those skilled in the relevant arts.

Disk 50 comprises threaded opening 52, opening 82 with enlarged ends 84 and 122, opening 126, and a flange 54 having an outside diameter 58. Threaded opening 52 is adapted for receiving a bolt such as bolt 28 illustrated in FIG. 2 or shoulder bolt 228 illustrated in FIG. 10. Opening 82 and enlarged end 84 are adapted to receive pressure sensor assembly 90. Enlarged end 122 is adapted to receive pressure sensor assembly cover 124. Opening 126 is adapted to accept extension 134 of connector 130. Outside diameter 58 is adapted for welding, preferably by a laser welder, to surface 77 of sleeve 40. Disk 50 is preferably made by cutting a disk from steel plate using a hole saw having a step that forms flange 54 while cutting out the disk. A coining operation forms the lower surface of disk 50 and pierces or expands a smaller hole to form a hole suitable for making threads 52T and, thereby, relocating metal to form the thicker region around threaded opening 52. After coining, openings 82, and 126 are made by convention processes such as drilling, reaming, and milling; and threads 52T are made by cutting or rolling. Disk 50 is preferably made of cold rolled low carbon steel selected to minimize the total cost of the steel plus the cost of forming and welding. If higher strength threads 52T are required to meet requirements defined by customers or government safety standards, a hardened threaded insert (not illustrated) may be used. Other materials and designs for disk 50 and methods other than coining may be substituted by those skilled in the relevant arts.

Data 150 is preferably burned onto disk 50 using a laser after completed load cell 30 has been tested. It comprises information that may include a serial number, manufacturing date, component-tracking information, and information about the performance of the load cell such as information about how the output varies with applied force and temperature. Date 150 may be recorded at another location such as on connector 130 or base 44. Data 150 may be recorded in any format known to be suitable or that meets buyer specifications. Data 150 may also be stored electronically in such as an electronic memory incorporated in pressure sensor 92 or located elsewhere, for example, in such as an ASIC (not illustrated) or it may be stored in other ways known to those skilled in the relevant arts.

Cover 64 for covering threaded opening 52 is preferably made by cold forging a disk of mild steel. It is attached, preferably by laser welding at its outside diameter 88, (weld #0) to disk 50 to form a hermetically sealed joint; the combination forming surface 56 comprising the combination of the underside of cover 64 and the underside of disk 50 beyond the outside diameter 88 of cover 64. Surface 56 closely matches the shape of the combination of the upper surface of spring 46 and surface 66 of base 44.

The combination of disk 50 and cover 64 operates to reduce the effect stress applied to threads 52T of threaded hole 52 has on the load cell output by isolating the surface in contact with liquid 60 from the metal near the threads, thereby minimizing the sensitivity of load cell 30 to the tightness of the attaching bolt. Making top 42 of two parts also reduces manufacturing cost by enabling disk 50 to approximate the simple shape of a washer whereby disk 50 can be formed by the low cost process of coining a disk cut from steel plate. Other materials and designs for cover 64 may be substituted by those skilled in the relevant arts.

Cover 124 for covering the pressure sensor assembly is preferably a disk made of mild steel having the same thermal expansion coefficient as disk 50. It may be attached to disk 50 by welding or by an adhesive or by other processes known to be suitable by those skilled in the relevant arts.

Other materials and manufacturing processes for making top 42 may be substituted by those skilled in the relevant arts.

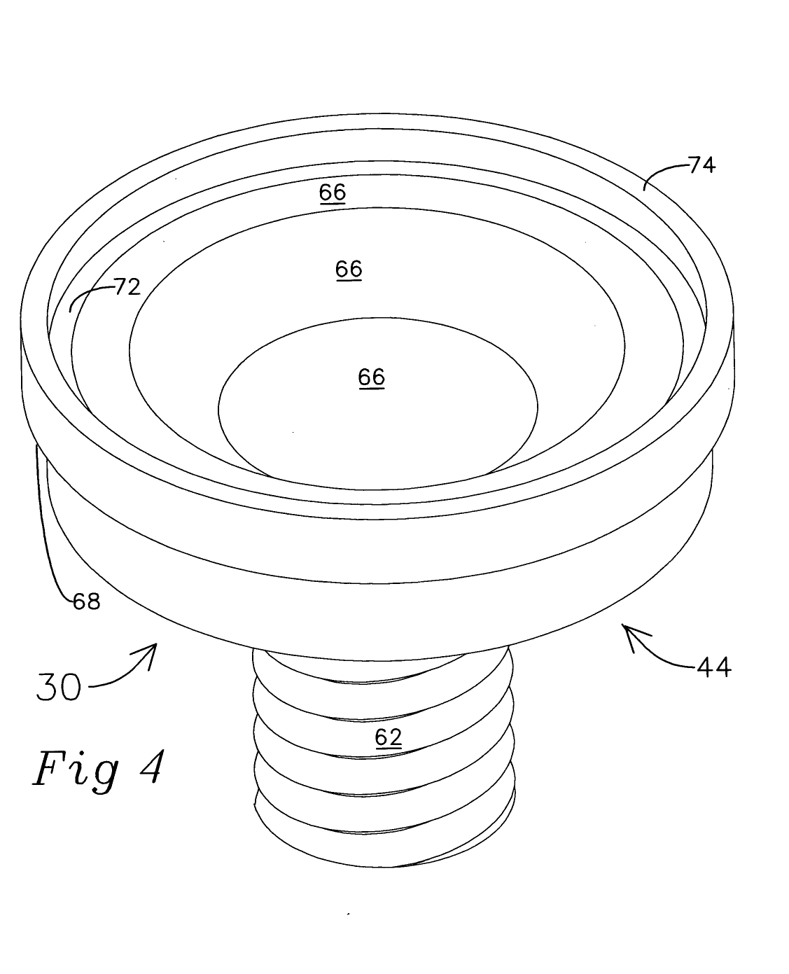

Referring now to FIGS. 3 and 4, base 44 of load cell 30 comprises a threaded stud 62 and an enlarged head having surface 68 for attaching by welding to the inner flange of lower spring 48, surface 72 for welding to the inner flange of upper spring 46 and surface 66. Except for the threads on stud 62, base 44 is symmetric about axis 30′. Surfaces 68 and 72 of base 44 are angled at an angle less than ninety degrees from axis 30′ to enable access by a laser beam during welding. If friction welding is used, it would be preferably for surfaces 68 and 72 to be perpendicular to axis 30′. Extension 74 of base 44 beyond surface 72 is optional and may be provided to assist in positioning spring 46 during welding. Surface 66 is shaped to match surface 56 of top 42. Base 44 is preferably made of steel selected to have sufficient strength to meet requirements and to minimize the total cost of the steel plus the cost of forming and welding.

Base 44 is preferably made by cold heading using conventional bolt making equipment. This process comprises: 1) Inserting a cylindrical slug into the cold heading tool; 2) If necessary, a reduced diameter portion is formed by swaging prior to cold heading or the stud portion is extruding to form the portion to be threaded; 3) The cold header strikes the slug to form the slug into the desired shape; and 4) The threads are formed by rolling. A process to reduce the diameter of a portion of the slug to a diameter suitable for rolling threads is required if the amount of metal in the enlarged head of base 44 is so large that the enlarged head cannot be cold headed from a slug having a diameter suitable for rolling the threads.

The material and process for making base 44 depends on the requirements stud 62 must meet. For one application stud 62 was specified to meet the performance specifications of a metric grade 10.8 bolt. This required steel that yields at about 1000 megapascals. Tempered carbon steel is the conventional material for grade 10.8 bolts. Alternately and preferably, a dual phase steel with yield strength similar to the steel sold under the trademark DiForm 140 by the Ispat-Inland Steel Company is believed to be suitable for making base 44 by cold heading followed by thread rolling without subsequent heat-treating.

The steel for base 44 is selected jointly with selecting the welding method. Carbon steel requires a welding method such as friction welding that does not actually melt the materials being joined. Typically, dual phase steels can be welded to certain other steels by laser welding. Therefore, if a high strength stud is required the manufacturer may choose between making base 44 of high carbon steel and using friction welding, or using very high strength low carbon steel such as a dual phase steel and using a laser welding or a friction welding process. A lower cost alternative, if acceptable to the customer, is to make the stud larger in diameter and of lower strength steel that is suitable for both cold heading and laser welding. Other methods and materials for base 44 may be substituted by those skilled in the relevant arts.

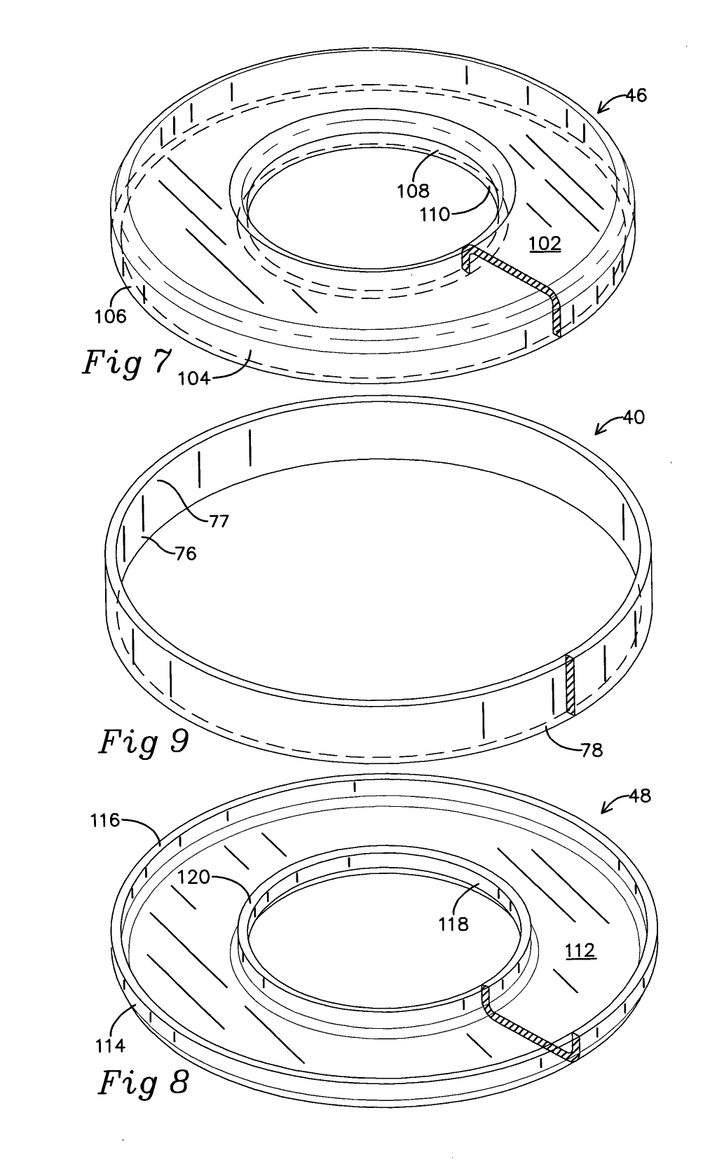

Referring now to FIGS. 3, 7 and 8, upper spring 46 and lower spring 48 are preferably formed by stamping or drawing spring steel into the shape of the surface of half of a torus of rectangular cross section as illustrated in FIGS. 7 and 8 respectively. If required, upper spring 46 and lower spring 48 are heat treated after forming. Upper spring 46 comprises a washer shaped disk 102 unitary with outer flange 104 and inner flange 108. Outer flange 104 has welding surface 106 on its outside diameter and inner flange 108 extends to welding surface 110.

Lower spring 48 comprises a washer shaped disk 112 unitary with an outer flange 114 that extends to welding surface 116 and an inner flange 118 that extends to welding surface 120. The preferred shapes for washer shaped disks 102 and 112 are slightly conical or dished shapes that become flat when load cell 30 is preloaded. A flat shape under preload is preferred because a flat washer shaped disk is believed to provide the best resistance to moments and radial forces. Disks 102 and 112 may be formed into their slightly conical or dished shapes by the stamping process or the conical or dished shape may result from forming the springs with flat washer shaped disks 102 and 112 by the stamping process followed by stressing to cause disks 102 and 112 to take on their slightly conical shapes.

Materials for springs 46 and 48 are selected to enable high quality welds to be made to the materials of which sleeve 40, top 42, and base 44 are made. Preferred spring materials are 17-7 precipitation hardened stainless steel or an ultra high strength low alloy steel known to be suitable for springs. Ispat-Inland sells an ultra high strength low alloy steel suitable for springs under the trade name Martinsite 190. Both 17-7 stainless steel and Martinsite 190 can be laser welded. If 17-7 stainless steel is selected springs 46 and 48 are formed to their final shape and heat-treated after forming. 17-7 steel heat-treated to condition TH 1050 was found to work well in one design. Martinsite 190 is believed to be preferred because it costs much less than 17-7 stainless steel and does not need heat-treating. The quality of the weld may be enhanced by truing the surfaces 110, 116, and 120. Other materials and methods for making springs 46 and 48 may be substituted by those skilled in the relevant arts.

Liquid 60 is confined from above by surface 56, which is formed by the combination of the lower surface of disk 50 and the lower surface of cover 64. Liquid 60 is confined from below by the combination of the upper surface 66 of base 44 and the upper surface of upper spring 46. The space between surface 56 of top 42 and the combination of surface 66 and the top surface of spring 46 forms a chamber containing liquid 60.

Proceeding now with particular reference to FIGS. 3 and 5, pressure sensor assembly 90 (shown in FIG. 3) comprises micro machined pressure sensor 92, glass core 94, metallic sleeve 96, feedthrough pins 98, and wires 98′. Metallic sleeve 96 is preferably projection welded to top 42 at weld 86 to form a hermetic seal between pressure sensor assembly 90 and disk 50. Alternately, while pressure sensor 92 is protected, metallic sleeve 96 may be laser welded to top 42. The header of pressure sensor assembly 90 comprises glass core 94 inside metallic sleeve 96 with feedthrough pins 98 extending through the glass core 94. The assembly of glass core 94, metallic sleeve 96, and feedthrough pins 98 is commercially available from suppliers of headers. Pins 98 are electrically insulated from metallic sleeve 96 by glass core 94. Micro machined pressure sensor 92 is preferably mounted on glass core 94 by a resilient epoxy adhesive (not illustrated). Pressure sensor 92 is preferably connected to pins 98 by wires 98′ bonded to the inside ends of pins 98 and to bonding pads (not illustrated) on pressure sensor 92. Complete pressure sensor assemblies suitable for pressure sensor assembly 90 are commercially available from IC Sensors of Milpitas, Calif. and others. Other materials and methods for making pressure sensor assembly 90 may be substituted by those skilled in the relevant arts.

Liquid 60 may be any of the liquids known to be compatible with the materials of which load cell 30 is made. A preferred liquid is one of the silicon based liquids designated DC200 fluids by Dow Corning of Midland, Mich. A 200 centipoise grade has been used with good results. Ethylene glycol has a smaller thermal expansion coefficient and is believed to be suitable. Other liquids may be substituted for liquid 60 by those skilled in the relevant arts.

Continuing to proceed with particular reference to FIGS. 3 and 5, connector 130 comprises four pins 140 insert molded into a thermoplastic structure comprising shroud 132, extension 134, seal cavity 136, and attachment openings 138. The number of pins is determined by pressure sensor 92 and other electrical components that a particular pressure sensor might require such as resistors and capacitors to protect against electrostatic discharge (ESD), a memory to store calibration data or an ASIC to both store calibration data and operate on the signal from the pressure sensor to provide such as compensation for temperature, etc. Shroud 132 and pins 140 within the shroud are adapted to mate with a conventional connector such as one of the connectors in commercial production for use in automobiles. Extension 134 comprises the inward extensions of the pins 140 encased by plastic that insulates the pins 140 from contact with opening 126 in disk 50. Openings 138 accept rivets 144 that have heads 146 and points 148. The points 148 are adapted for welding rivets 144 to disk 50 by fusion welding. Heads 146 engage connector 130 to attach it to disk 50. “O” ring 142 (illustrated in FIG. 3) provides sealing to keep liquids out of the cavity above pressure sensor assembly 90. Other connector designs and materials may be substituted by those skilled in the relevant arts.

Other metals known to be suitable by those skilled in the relevant arts may be used for the parts of load cell 30. The materials may be chosen to minimize the effect of temperature on the output of load cell 30. For example, the following was calculated: In a load cell having an outside diameter of about two inches and wherein springs 46 and 48 were stressed to provide a preload of about 100 pounds and the load cell was filled with Dow Corning DC200 fluid, viscosity 200 centipoise, a sleeve 40 and top 42 made of 304 stainless steel were found to minimize temperature effects when the other parts of load cell 30 were made of type 17-7 stainless steel precipitation hardened to condition TH 1050. The following was built and tested: A sleeve 40 made of 304 stainless steel was found to cancel the effect of temperature in load cell 30 having the aforementioned outside diameter and preload and filled with the aforementioned liquid when the top 42, base 44, and springs 46 and 48 of load cell 30 were made of heat-treated 17-7 stainless steel.

Many of the known finite element computer codes capable of modeling the operation of load cell 30 may be used to test different combinations of metals and liquid to determine a combination of materials and dimensions that provide a desired compensation for the effects of temperature on performance. The metals may be selected to minimize the change of pressure with temperature or the metals may be selected so that the pressure change with temperature compensates for variation in the response of micro machined pressure sensor 92 with temperature. Other combinations of materials may be substituted by those skilled in the relevant arts to achieve these or other desired performances.

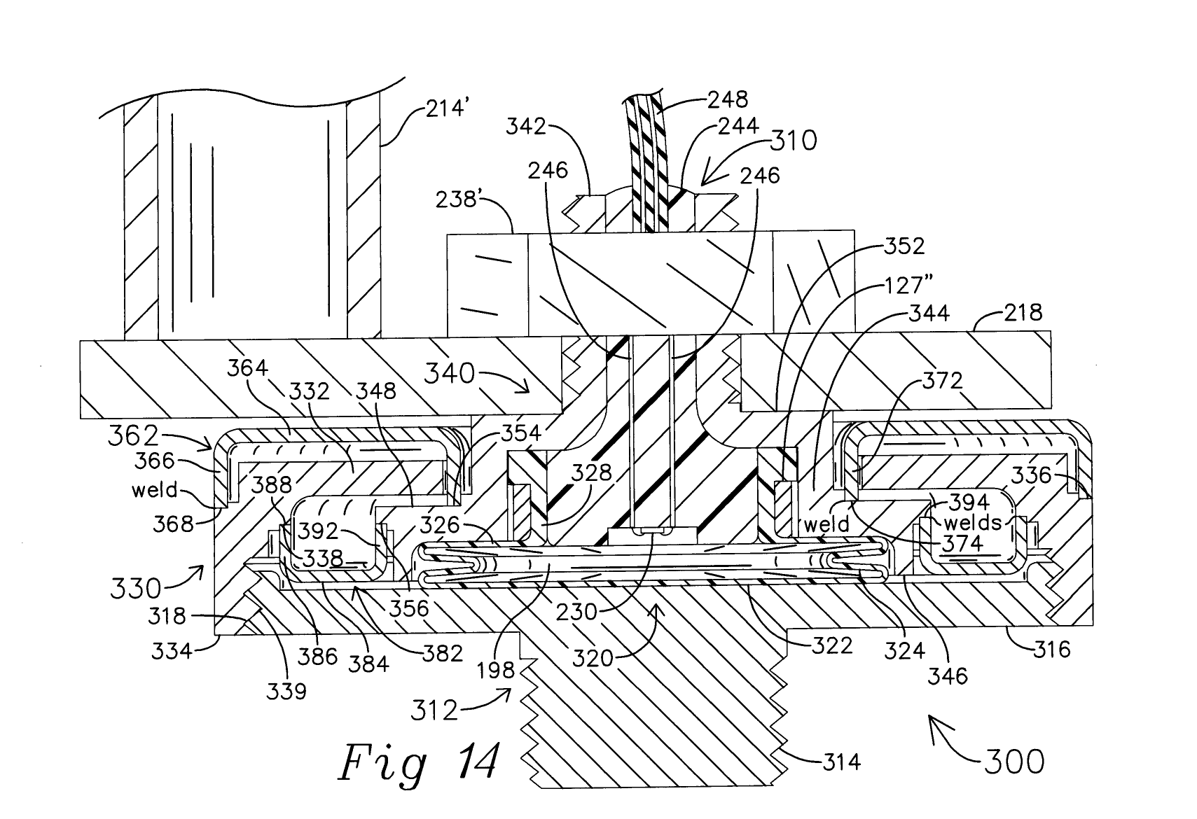

Force sensors other than the force sensor comprising liquid 60 and pressure sensor assembly 90 may be substituted by those skilled in the relevant arts. FIG. 14 illustrates a force sensor comprising a liquid filled injection stretch blow molded bottle having bellows shaped sides and a pressure sensor described in U.S. Pat. No. 6,259,167 has been demonstrated to operate to sense force in the load cell of the invention. That force sensor operates by converting axial force to pressure in the liquid for sensing by the pressure sensor.

Commercially available force sensors located between top 42 and base 44 may be substituted for liquid 60 and pressure sensor assembly 90 by those skilled in the relevant arts. A ball bearing retained by a rubber-like washer may be provided to isolate a force sensor from any sideways movement between top 42 and base 44. Semiconductor force sensors may be obtained from Fraunhofer of Germany. Alumina disk force sensors including strain gauge elements and required electronics are also commercially available. Kavlico of Moorepark, Calif. markets a line of capacitive force sensors of the type comprising an alumina disk.

If the fluid is omitted from load cell 30 springs 46 and 48 will operate as suspension springs that flex until movement is stopped by mechanical engagement. The flexing of the springs may be sensed by strain gauge elements (not illustrated) attached directly to the springs 46 and 48. Since springs 46 and 48 are also strained by moments and side forces it is necessary to provide arrays of strain gauge elements that produce signals that can be combined to cancel when strained by side forces and moments while not cancelling signals resulting from axial forces.

Preferred methods of manufacturing load cell 30 will now be described with particular reference to FIGS. 3 through 9. In preparation for assembly, sleeve 40, base 44, springs 46 and 48, disk 50, cover 64, pressure sensor assembly 90, cover 124, and connector 130 are made as described hereinabove. Cover 64 is welded to disk 50. If weld #0 is to be a laser weld, disk 50 and cover 64 are placed together in a fixture that rotates the two parts while a laser beam welds surface 88 of cover 64 to disk 50 at weld #0 illustrated in FIG. 3. Alternately, cover 64 may be welded to disk 50 by friction welding. A third alternate process is to weld cover 64 to disk 50 by projection welding. Other welding processes for joining cover 64 to disk 50 may be substituted by those skilled in the relevant arts.

The pressure sensor assembly 90 is sealed into the opening defined by surfaces 82 and 84. It is believed that a reliable seal requires welding by a process such as projection welding or seam welding, but load cells sealed with Loctite 609 sealant appeared to be sealed. Other header designs and other sealing methods known to be suitable may be substituted by those skilled in the relevant arts.

Next, surface 76 of sleeve 40 is welded to the outside diameter of the outer flange of spring 46 (weld #1 shown in FIG. 3). A preferred process for welding sleeve 40 to spring 46 comprises placing sleeve 40 and spring 46 in a fixture that keeps surface 76 of sleeve 40 against the outer flange of spring 46 and rotates the two parts while a laser beam is applied to the line identified by “weld #1” in FIG. 3. Other processes for making Weld #1 may be substituted by those skilled in the relevant arts.

If weld #2 (illustrated in FIG. 3) is to be a laser weld, then weld #2 must be performed before weld #3. This is done by placing base 44 and spring 48 in a fixture that holds the inner flange of spring 48 in contact with surface 68 of base 44 while rotating them. A laser beam is applied to perform weld #2.

If base 44 and spring 48 are to be friction welded (weld #2) then performing weld #2 is preferably delayed until weld #1 and weld #3 (referring to FIG. 3) are performed. A preferred method for performing weld #2 by friction welding after performing weld #3 comprises: (1) placing the assembly of sleeve 40, spring 46 and base 44 in one chuck of a friction welding machine and placing spring 48 in the other chuck and causing one of the chucks to rotate; (2) bringing the inner flange of spring 48 and surface 68 of base 44 together while, simultaneously, bringing the outer flange of spring 48 and surface 78 of sleeve 40 together and keeping the surfaces together until weld #2 and weld #4 are completed. During welding the axial positions of both the inner flange and outer flange of spring 48 are controlled by the fixture relative to the assembly comprising sleeve 40, base 44, and spring 46 so that springs 46 and 48 are in their relaxed positions after weld #2 and weld #4 are completed. One circumstance requiring friction welding is if base 62 or spring 48 or both are made of steels such as high carbon steels or other steels that cannot be welded by processes that melt the metals at weld #2 or weld #4.

Other methods or processes for performing weld #2 and weld #4 may be substituted by those skilled in the relevant arts.

To perform weld #3 by laser welding the subassembly of sleeve 40 and spring 46 and base 44 or the subassembly of base 44 and spring 48 are placed in a fixture that holds surface 110 of the inner flange of spring 46 in contact with surface 72 of base 44 while rotating them and the laser beam is applied while the parts are being rotated. If spring 48 is present, weld #4 may be performed using the same fixture by applying a laser beam to where surface 116 of the outer flange of spring 48 contacts welding surface 78 of sleeve 40. If a second laser is available or if the beam of the laser can be split both welds may be performed simultaneously.

To perform weld #3 by friction welding, base 44 and the assembly of sleeve 40 and spring 46 that were previously welded are brought together in a friction welding machine. During friction welding, spring 46 must be supported by both its upper and lower surfaces so it is not stressed during friction welding, which applies substantial axial force and torque. Friction welding will create some upset material at weld #3 that is preferably removed in the friction welding machine by using a lathe type of cutting tool to cut upset material from the inside diameter of spring 46 and surface 66 before it has had time to cool and fully harden. During friction welding, the axial positions of the assembly of sleeve 40 and spring 46 are accurately monitored; and rotation and axial movement are programmed to stop so that spring 46 is accurately located relative to base 44. Alternately, extra material (not illustrated) is provided on surface 66 and the extra material is removed when the upset material is removed to accurately position surface 66 relative to the upper surface of spring 46. Weld #2 and weld #4 are performed as described hereinabove after weld #3 is friction welded.

An alternate to accurately locating surface 66 relative to spring 46 when friction welding is used to perform weld #3 is to turn surface 56 using a lathe to make surface 56 fit closely to the surface of the combination of base 44 and upper spring 46. For this purpose, after the assembly comprising sleeve 40, base 44, and spring 46 is completed the surface comprising the surface 66 of base 44 and the upper surface of spring 46 is probed at enough points to ascertain its profile. Surface 56 of top 42 is then turned on a lathe to match the profile determined by the aforementioned probing, thereby minimizing the gap between surface 56 and the surface comprising the surface 66 of base 44 and the upper surface of spring 46, whether caused by welding or something else.

The product of the aforementioned steps is two assemblies, the top 42 and the assembly built upon base 44. The two assemblies are preferably joined by welding flange 54 of top 42 to surface 77 of sleeve 40 of the assembly of sleeve 40, base 44, spring 46, and spring 48. To achieve consistent performance, the space between surface 56 and the surface comprising the top of spring 46 and surface 66 of base 44 must be consistent from part to part. This is achieved by putting the aforementioned surfaces in contact during welding, whereby there is no gap when the weld is complete. The gap containing liquid 60 illustrated in FIG. 3 largely results from springs 46 and 48 being flexed by preloading, which separates the aforementioned surfaces and provides a volume to contain liquid 60.

To perform weld #5 the parts are preferably placed in a fixture that rotates the parts while holding the lower surface 56 of top 42 and the adjacent surface of spring 46 in contact. The laser beam is then applied to form weld #5. Placing surface 56 of top 42 and the adjacent surface of spring 46 in contact minimizes the space for liquid 60 and makes it constant from part to part, which minimizes the amount of liquid 60, which minimizes the effects of differential thermal expansion, which minimizes the required temperature compensation. Other manufacturing methods and materials may be substituted by those skilled in the relevant arts.

The manufacture of load cell 30 is completed by filling load cell 30 with liquid 60, installing connector 130, connecting the pins 140 of connector 130 with the pins 98 of pressure sensor assembly 90, and installing cover 124.

For filling with liquid 60, load cell 30 is preferably placed in a vacuum until substantially all air is exhausted while predetermined force is applied between top 42 and base 44 that causes springs 46 and 48 to flex to form a volume between surfaces 56 and 66 as illustrated in FIG. 3. The liquid 60 is then injected through a filling tube in pressure sensor assembly 90 (not illustrated) at a sufficient pressure to fill all voids. After filling, the filling tube is closed by heating the end of the filling tube to form a bead of melted metal or by another known process for sealing the end of a small diameter tube.

The larger thermal expansion of the liquid 60 relative to the metal parts of load cell 30 requires temperature compensation proportional to the amount of liquid 60. Some or all of the temperature compensation is preferably provided by making sleeve 40 of type 304 stainless steel. Therefore, the load cell requires temperature compensation proportional to the amount of liquid 60 less a constant determined by the thermal expansion coefficient of sleeve 40. Therefore, precise temperature compensation may be achieved by accurately controlling the amount of liquid 30 injected to be exactly the amount that negates the compensation provided by sleeve 40. The temperature compensation provided by sleeve 40 may be augmented or obviated by providing an ASIC to compensate the output of pressure 20 sensor assembly 90 for temperature or by designing processing unit 36 (illustrated in FIGS. 1 and 2) to compensate the signals it receives for temperature.

In a last step in its manufacture, load cell 30 is tested over a range of temperatures and applied loads to determine the aforementioned numbers that define the required compensation for temperature, scale, and non-linearity; and those numbers are permanently stored in load cell 30. Alternately, the load cells 30 and processing unit 36 may be made unitary by omitting connector 130 and permanently wiring load cells 30 to processing unit 36; in which case the aforementioned numbers are permanently stored in processing unit 36.

The materials, methods and designs referred to hereinabove are only suggestions and other materials, methods, and designs may be substituted by those skilled in the relevant arts.

The operation of the seat occupant weight sensing system 20 of the invention will now be described with reference to FIGS. 1 through 3. In operation of the system, when seated occupant 12 applies downward force to seat cushion 16 and seat back 14 the force is transmitted to an upper frame that comprises upper frame member 22. Upper frame member 22 applies the downward force to the four load cells 30. Load cells 30 each transmit a signal through an electrical cable 36′ to processing unit 36 indicating the applied force. If load cells 30 comprise absolute pressure sensors and processing unit 36 contains an atmospheric pressure sensor the microprocessor of processing unit 36 subtracts the atmospheric pressure from the pressure inside each load cell 30 and multiplies the difference by a factor that, for maximum accuracy, may be specific to each load cell 30. Each product is the sum of the downward component of the force being applied to load cell 30 plus the preload force. The microprocessor of processing unit 36 subtracts from the force indicated by each load cell the force registered at a previous time for that load cell when the seat was empty. The sum of the four differences thus computed is the weight of the occupant of seat 10. Processing unit 36 may combine the information from load cells 30 with other information, such as seat belt tension indicated by seat belt tension sensor 252 or 252P, to further characterize the seat occupant.

The operation of load cell 30 will now be described with particular reference to FIGS. 1 through 3 and 10. When a force is applied to top 42 of load cell 30 aligned with the direction of axis 30′ of load cell 30, that force is applied to liquid 60 over the area of surface 56, which increases the pressure in liquid 60 by an amount proportional to the applied force. The pressure is sensed by pressure sensor 92, which generates an electric signal, which is transmitted through conductors 98′, header pins 98, conductors 128, and connector pins 140 to the outside of load cell 30. The electric signal is transmitted through electrical cable 36′ to processing unit 36. When downward force is applied to load cell 30 there is a slight compression of the liquid 60 and a slight flexing of springs 46 and 48 with a slight downward movement of top 42 relative to base 44. This movement is very small because liquid 60 is substantially incompressible and because the amount of liquid 60 is small.

The flexing of the springs 46 and 48 is illustrated in FIG. 10. In FIG. 10 the stressed shapes of springs 46 and 48 in which spring 46 and 48 are providing preload are illustrated with solid lines and the unstressed shapes are illustrated with dashed lines. The stressed shapes are the shapes illustrated in FIG. 3. In FIG. 10 it will be seen that the inner flange and nearby parts of disk 102 and 112 of the unstressed (shown with dashed lines) springs 46 and 48 respectively are offset upward by a small amount from the corresponding parts of the stressed springs. A shifted top 42 is not illustrated in order to increase the clarity of FIG. 10. It can be seen that when springs 46 and 48 are not stressed, surface 56 and the combination of surface 66 and the upper surface of spring 46 are in contact and there is no space between them for liquid 60. The space for liquid 60 between surface 56 and the combination of the top of spring 46 and surface 66 results from preloading. It can also be seen that the washer shaped component 112 of unstressed lower spring 48 and the washer shaped component 102 of unstressed upper spring 46 are conical to a degree such that the washer shaped components 102 and 112 will be flat when they are stressed by preloading to the shapes illustrated in FIG. 3. It is believed that designing springs 46 and 48 so that their components 102 and 112 are flat after preloading minimizes sensitivity to moments and side forces.

The operation of load cell 30 of the invention will now be described with particular reference to FIGS. 3 and 10. When shoulder bolt 228 is tightened, compression forces are applied to the region of top 42 surrounding threaded opening 52, which slightly compresses the metal surrounding threads 52T and draws it upward toward the head of shoulder bolt 228. The physical separation between cover 64 and the metal surrounding threads 52T prevents the lower surface 56 from being drawn upward by the tightening of bolt 228 and affecting the output of load cell 30, which is responsive to the position of surface 56. When the lower surface of the material surrounding threaded opening 52 is drawn upward by bolt 228, the lower surface 56 remains unmoved because cover 64 is separate from material adjacent threaded opening 52, which enables the output of the force sensor to be unaffected by the torque applied to bolt 228.

Continuing with particular reference to FIGS. 3 and 10, when a force or moment is applied to load cell 30 between top 42 and base 44 perpendicular to the axis 30′ of load cell 30 this force is resisted by springs 46 and 48. Springs 46 and 48 operate to maintain the axes of symmetry of top 42 and base 44 in alignment in the presence of both side forces and moments. Side forces and moments do not change the relative axial position between top 42 and base 44 so the pressure in liquid 60 is, approximately, unchanged. In fact, side forces and moments cause slight distortions in spring 46 and even smaller distortions in top 42 and base 44. These slight distortions cause small changes in the pressure in liquid 60. These small changes were found, in one design, to cause less than one percent of the pressure change the same forces cause in liquid 60 when applied parallel to axis 30′.

Continuing with particular reference to FIGS. 2 and 10, means are provided to limit side force applied to load cell 30. When relative thermal expansion or other effects operate to exert a substantial side force such as one hundred pounds between seat frame member 22 and load cell 30 seat frame member 22 slips between washers 226. Washers 226 are prevented from moving perpendicular to axis 30′ of load cell 30 by the engagement between the inside diameters of washers 226 and unthreaded portion 228′ of shoulder bolt 228. The spring nature of washers 226 causes sufficient force between washers 226 and upper seat frame member 22 that smaller sideways forces do not cause slippage. This operates to minimize the effects of side forces on the output of load cell 30 by limiting side forces to values that do not cause slippage between upper seat frame member 22 and washers 226. This operates to limit the effect of forces resulting from such as differential thermal expansion between two vehicle components to which a load cell 30 is attached.

The operation of load cell 30 when there are temperature changes will now be described with particular reference to FIG. 3. FIG. 3 illustrates a thin gap filled with liquid 60. Over the range of operating temperatures from −40° C. to +100° C. the thermal expansion of the liquid will cause the volume of the liquid 60 to vary between a low value and a high value that is typically eight to fourteen percent larger than the low value, depending on the liquid used. For a simple example, suppose that the sleeve 40, top 42, base 44, and springs 46 and 48 of load cell 30 are all made of the same material such as tempered 6150 spring steel or phase hardened 17-7 stainless steel. This is approximated by a load cell in which all the materials have approximately the same thermal expansion coefficient, whereby there is no differential thermal expansion and the volume containing liquid 60 attempts to expand with temperature the same as the metal, which would increase the volume for liquid 60 less than one percent when the temperature rises from −40° C. to +100° C. The liquid 60 will expand much more than one percent, which will cause top 42 to move farther from base 44, thereby further straining springs 46 and 48 and increasing the pressure in liquid 60 in proportion to the increase in the deflection of the springs. The pressure increase in liquid 60 will be proportional to the volume of liquid 60 as the volume of the liquid increases eight to fourteen percent as the temperature goes from −40° C. to +100° C. Therefore, if the miscellaneous volumes such as the volume around pressure sensor 92 are small relative to the volume adjacent surface 56 so that the volume containing liquid 60 is substantially the volume created by the preloading, illustrated by the displacement of the springs from the unstressed springs illustrated in FIG. 10, the temperature going from −40° C. to +100° C. will cause the pressure to change about eight to fourteen percent of the pressure caused by the preload force. For example, if the preload is one hundred pounds, the change in indicated force might be eight to fourteen pounds.

In a second example, if sleeve 40 is made of type 304 stainless steel and the other aforementioned parts are, as in the previous example, made of materials having the same thermal expansion coefficient that is less than that of 304 stainless steel, then the variation of the output with temperature will be reduced. Further, there will be approximately zero variation of pressure with temperature at a predetermined spring preload. This is explained in the following paragraphs. For reference, the thermal expansion coefficient of 304 stainless steel is about 10.0 parts per million per degree F. The thermal expansion coefficient of the steel parts is about 6 parts per million per degree F. This causes sleeve 40 to expand or contract much more during temperature changes than the other parts.

The different thermal expansion coefficients cause two things happen during a rise in the temperature:

1. During a temperature rise sleeve 40 will expand more in the radial direction than top 42 and the outer flange of spring 46, which increases the volume for liquid 60 between the inner surface of sleeve 40 and combination of the outer diameter of top 42 and the outer diameter of the outer flange of spring 46. In a particular design having an outside diameter of about two inches this factor increased the volume available to the liquid by about 16 mm³ (0.001 in³) over the aforementioned temperature range.

2. During a temperature rise the height of sleeve 40 will increase more than the height of the outer flange of spring 46. This opens the gap between surface 56 and the surface comprising the surface 66 of base 44 and the upper surface of spring 46 by the amount of the differential expansion. In the aforementioned design having an outside diameter of about two inches this factor increased the volume available to the liquid by about 10 mm³ (0.0006 in³) over the aforementioned temperature range.

The two above recited effects operate in concert to increase the space available for liquid 60 at higher temperatures. Similarly, during a fall in temperature the reverse of the two above described effects operate to decrease the space available for liquid 60. At a predetermined volume of liquid 60, which corresponds to a predetermined preload (assuming the volume is near zero without preload) the additional volume provided by these effects of temperature change allow liquid 60 to expand without further stressing springs 46 and 48. At this predetermined volume of liquid 60, the pressure in load cell 30 does not change with temperature. For the aforementioned design having an outside diameter of about two inches the two factors 1) and 2) increased the volume available to the liquid by about the amount the volume of the liquid increased over the aforementioned temperature range for a preload of about one hundred pounds. This was the desired preload for that sensor and the two effects made the variation of the output of that sensor with temperature be approximately zero.

The materials and dimensions such as the dimensions of the springs 46 and 48 and top 42, and the height and inside diameter of the sleeve 40 are jointly selected to determine the preload at which constant output over temperature is achieved.

The materials and methods referred to hereinabove are only suggestions and other materials and methods may be substituted by those skilled in the relevant arts.

Proceeding now with particular reference to FIGS. 1, 2 and 11 through 13, an exemplary method of operation of seat occupant weight sensing system 20 for the cases wherein seat belt tension sensors are provided is presented: When power is first turned on and the vehicle engine is started, processing unit 36 receives pressure readings from load cells 30. Processing unit 36 then calculates the weight applied to the seat from the pressure sensor outputs as described hereinabove with reference to FIGS. 1 through 10. If the weight is less than a predetermined weight then processing unit 36 registers that the seat is not occupied and that the occupant protection system for that seat should not be deployed. If the weight is larger than the aforementioned predetermined weight then processing unit 36 tentatively registers a seat occupant weight based on the output of load cells 30.

If a seat belt tension sensor 252 or 252P is present, processing unit 36 continues by determining if seat belt tension sensor 252 or 252P indicates tension greater than a predetermined force. If seat belt tension sensor 252 or 252P continues to indicate a tension greater than the predetermined force for longer than a momentary time then processing unit 36 changes its previous decision and tentatively registers that the seat is occupied by a belted child seat and that the weight of the occupant is unknown. This is quite likely to be correct but there is a small probability that an adult has tightened the seat belt unusually tight. This is likely to be resolved by the adult loosening the belt. In the case where the weight is very large such as more than 160 pounds the microprocessor may indicate that the occupant is an adult regardless of the seat belt tension.

A seat belt tension sensor 252 or 252P may operate as a switch with two discrete states or may operate as a sensor having an output monotonically varying with seat belt tension. A tension sensor having a monotonically varying output may be used to resolve ambiguities regarding whether a seat occupant is a child in a child seat tightly belted to the vehicle seat or is an adult. For seat belt designs wherein the shoulder belt is not under tension, the measured weight of a seated occupant is adjusted by subtracting twice the vertical component of the seat belt tension from the measured seat occupant weight. For example, if the tension in the seat belt remains constant at 8 pounds then 16 pounds times the cosine of the angle of the belt from the vertical is subtracted from the measured weight. For seat belt designs wherein the shoulder belt is under the same tension as the seat belt the belt tension times the cosine of the shoulder belt angle from the vertical is added to correct the measured occupant weight. For example, if the occupant is a child in a tightly belted child seat with tension in the shoulder belt the measured weight is reduced by approximately the belt tension (approximately twice the belt tension less approximately the belt tension) to estimate the weight. These processes unambiguously measure the weight of the seat occupant.

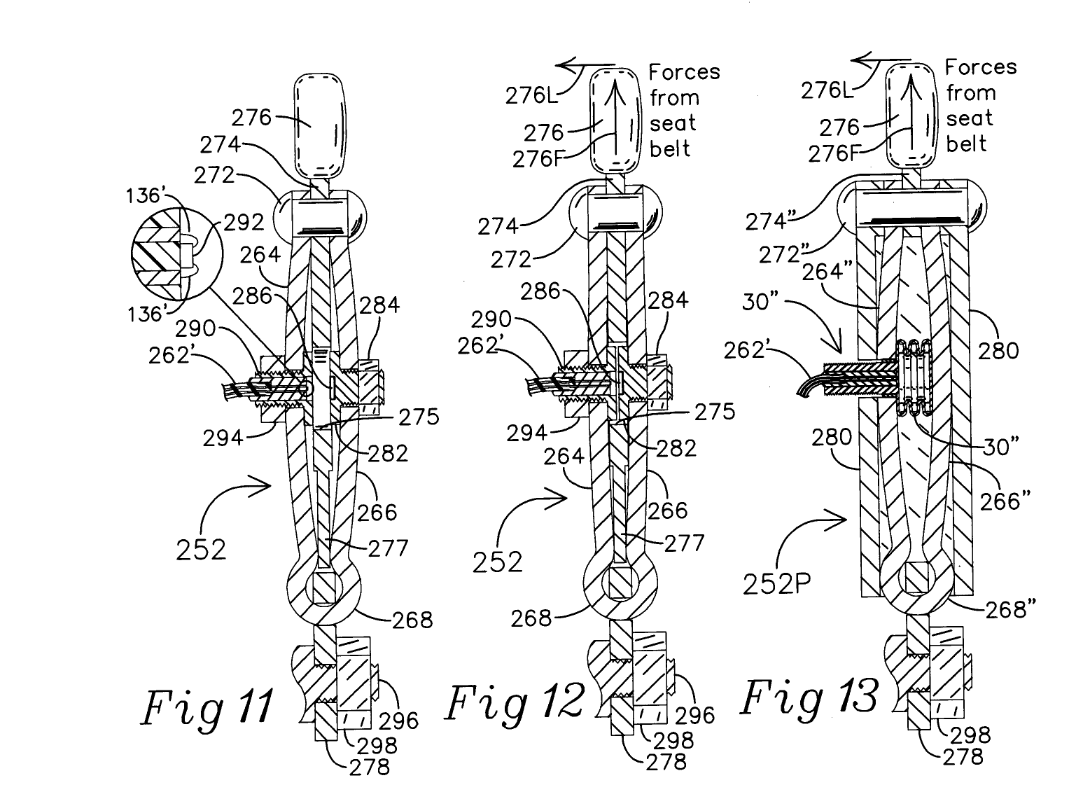

Proceeding now with particular reference to FIGS. 11 and 12, seat belt tension sensor 252 comprises two bowed metal bands 264 and 266 unitary at their lower ends with loop 268. Bands 264 and 266 are joined at their upper ends by rivet 272 to extension 274 of seat belt latch 276. Loop 268 attaches bands 264 and 266 to anchor 278 and forms a flexible joint that allows seat belt tension sensor 252 to rotate about the axis of loop 268. A permanent magnet 286 mounted in a holder 282 is attached by nut 284 to band 266. A magnetic field sensor 292 is mounted on a holder 290, which is attached by nut 294 to band 264. Anchor 278 is attached to seat 10 by stud 296 and nut 298. Anchor 278 may be attached to the body of the vehicle instead of to seat 10.

Bands 264 and 266 are preferably unitary with loop 268 and formed of a strip of HSLA steel. Alternately, a nonmagnetic stainless steel may be used to prevent magnetization of the bands 264 and 266, which could affect performance. Cold rolled type 304 stainless steel operates as a spring and is at most only slightly magnetic. Rivet 272 may be any conventional fastener such as a rivet suitable for providing a strong joint between bands 264 and 266 and extension 274.

Seat belt latch 276 may be any conventional seat belt latch or tongue for joining the two parts of a seat belt. Extension 274 is preferably made of steel with an opening 275 and bearing end 277. Extension 274 is strongly attached to seat belt latch 276 for transmitting the full force applied by an occupant to the seat belt during a vehicle crash. Opening 275 forms a passage through which magnet 286 and magnetic field sensor 292 can approach each other when seat belt tension is applied. Bearing end 277 fits slidingly between bands 264 and 266 where they join loop 268. Bearing end 277 may be plated or coated with a material (not shown) to minimize wear and friction during the lifetime of the vehicle.

Anchor 278 is preferably stamped from sheet steel with an opening sized to accommodate loop 268 and a second opening sized to accommodate stud 296. Stud 296 may be a conventional threaded stud as illustrated in which case nut 298 holds anchor 278 fixedly in its position when tightened. Stud 296 may also have a stud shoulder (not illustrated) for nut 298 to abut, which would allow anchor 278 to rotate about stud 296. If the aforementioned stud shoulder (not illustrated) is provided means may be included to limit the rotation of anchor 278 about stud 296.

Magnet 286 is preferably a disk formed of a permanent magnet material. One of the alnico compositions that does not require a keeper or a samarium cobalt composition is preferred because the variation of the magnetic field with temperature is small. Other permanent magnet materials may be substituted by those expert in the field of magnetic position sensing. Magnet 286 is mounted in holder 282, which may be made of plastic or metal. If holder 282 and bands 264 and 266 are made of magnetically soft material, magnetic flux will carried by the holder 282 and bands 264 and 266, which will make the magnetic field at magnetic field sensor 292 slightly dependent on the magnetic qualities of bands 264 and 266. The assembly of magnet 286 and holder 282 is mounted by nut 284 to band 266. Other known means for measuring distance between bands 264 and 266 may be substituted by those skilled in the relevant arts.

Magnetic field sensor 292 may be a commercially available Hall effect magnetic field sensor designed for the expected range of magnetic fields. For a two state output a Hall effect switch may be used; for monotonically varying output a linear Hall effect magnetic field sensor may be used. For smaller magnetic fields a magnetic field sensor based on a magnetoresistive effect and designed for the expected range of magnetic fields may be used. A cover (not illustrated) may be provided to protect magnetic field sensor 292. For a two state output magnetic field sensor 292 may be a reed switch. Many suitable magnetic field sensors are commercially available from sensor or electronic component suppliers.

Other known distance sensors may be substituted for the combination of permanent magnet 286 and magnetic field sensor 292. Such sensors as capacitive distance sensors, eddy current distance sensors, optical distance sensors and others may be substituted by those skilled in the art of distance sensing.

The materials and methods referred to hereinabove are only suggestions and other materials and methods may be substituted by those skilled in the relevant arts.

The operation of the seat belt tension sensor 252 of the invention will now be described with particular reference to FIGS. 11 and 12. When there is no seat belt tension, bands 264 and 266 are bowed to the maximum amount as illustrated in FIG. 11. This causes permanent magnet 286 and magnetic field sensor 292 to be at their maximum distance from each other. The magnetic field at magnetic field sensor 292 increases as the distance from permanent magnet 286 decreases. Therefore, the output of magnetic field sensor 292 or other distance sensor is at its minimum or one extreme of its output in the configuration illustrated in FIG. 11 and is near its maximum or other extreme of its output in the configuration illustrated in FIG. 12.

When tension in the seat belt indicated by arrow 276F is applied to seat belt latch 276, the tension is transferred to extension 274, which applies the tension through rivet 272 to bands 264 and 266. The tension in bands 264 and 266 causes them to straighten toward the straightness illustrated in FIG. 12.

When bands 264 and 266 straighten under tension, magnet 286 is brought closer to magnetic field sensor 292. The closer magnet 286 is to magnetic field sensor 292 the greater is the magnetic field at magnetic field sensor 292. Therefore, the magnetic field at magnetic field sensor 292 is greater when there is greater tension in the seat belt.

Accordingly, if the output of magnetic field sensor 292 or other distance sensor is binary it switches as the tension 276F the seat belt applies to seat belt latch 276 increases past a predetermined tension. The output of magnetic field sensor 292 or other distance sensor is connected through cable 262′ to processing unit 36 to which it indicates if the tension 276F received by seat belt latch 276 is above or below a predetermined tension. The precise value of the tension 276F that causes the output of magnetic field sensor 292 or other distance sensor to switch state depends on the stiffness and curvature of bands 264 and 266 and other specific features of the design. Other methods for relating magnetic field to a binary output may be substituted by those skilled in the relevant arts.

If magnetic field sensor 292 or other distance sensor is of a type having output that varies linearly or monotonically as the distance decreases the output also varies monotonically as the seat belt applies increasing tension 276F to seat belt latch 276. The output of the distance sensor is connected through cable 262′ to processing unit 36 to which it indicates the tension 276F received by seat belt latch 276. The precise relationship between the tension 276F applied to seat belt tension sensor 252 and the output of the distance sensor depends on the stiffness and curvature of bands 264 and 266 and other specific features of the design. One method for processing unit 36 to derive the seat belt tension from the signal from the distance sensor is for a table containing measured seat belt forces corresponding to distance measurements to be stored in the microprocessor of processing unit 36 When a distance signal reaches processing unit 36, processing unit 36 finds the entry in the table corresponding to the received signal and reads the corresponding seat belt tension from the table. Other methods for relating sensor output to seat belt tension may be substituted by those skilled in the relevant arts.

The seat belt may apply a lateral force such as is indicated by arrow 276L in FIG. 12 in addition to the axial force indicated by arrow 276F. This can happen if free rotation of seat belt tension sensor 252 about loop 268 is prevented. The lateral force applies a torque to seat belt latch 276 and to extension 274. If extension 274 did not have its extended length but terminated immediately below rivet 272 (for example, extension 274″ illustrated in FIG. 13) then the torque would distort bands 264 and 266 and make the seat belt tension readings depend on both the tension and the angle at which the tension is applied to latch 276. The extended length of extension 274 prevents this by transferring the torque to the contact between end 277 of extension 274 and loop 268 between bands 264 and 266 thereby preventing the torque from being applied to bands 264 and 266 at rivet 272 and affecting the accuracy of seat belt tension sensor 252.

Continuing now to describe with particular reference to FIGS. 1, 2 and 11 through 13 the aforementioned exemplary method of operation of seat occupant weight sensing system 20 in the cases wherein it comprises a seat belt tension sensor: During normal operation of the vehicle when there is little or no seat belt tension, the resiliency of bands 264 and 266 cause them to remain in their curved states illustrated in FIG. 11. Bands 264″ and 266″ are always in their curved states illustrated in FIG. 13. In the case of sensor 252 the output of magnetic field sensor 292 or other distance sensor is at its minimum. In the case of sensor 252P the output of force sensor 30″ or other force sensor is at its minimum. In either case the outputs indicate there is no tension in the seat belt.

For momentary periods lasting a few seconds, such as during hard braking and on rough roads, the seat belt (not illustrated) applies upward force 276F to seat belt latch 276. In the case of seat belt tension sensor 252 upward force 276F causes bands 264 and 266 to momentarily straighten and bring the parts of magnetic field sensor 292 or other distance sensor closer together to produce an output indicating the seat belt tension for the aforementioned momentary periods. In the case of seat belt tension sensor 252P upward force 276F causes bands 264″ and 266″ to apply force to force sensor 30″ or other force sensor to produce an output indicating the seat belt tension for the aforementioned momentary periods.

Processing unit 36 monitors the output of magnetic field sensor 292 or other distance sensor or force sensor 30″ or other force sensor and, if the increased output is momentary, takes no action. If a child seat (not illustrated) is tightly belted into seat 10 then the seat belt (not illustrated) may apply a constant upward force 276F to seat belt latch 276 causing the output of magnetic field or distance sensor 292 or other distance sensor or force sensor 30″ or other force sensor to go to a level indicating a high belt tension and remain at that level indefinitely. Conductors of cable 262′ communicate the output of magnetic field sensor 292 or other distance sensor or force sensor 30″ or other force sensor respectively to processing unit 36. If the distance determined by magnetic field sensor 292 or other distance sensor or the force sensed by force sensor 30″ remains at an approximately constant value for an extended period such as twenty seconds; processing unit 36 calculates the weight of the seat occupant, preferably by a process comprising the following two steps:

In the first step, the microprocessor of processing unit 36 measures the seat occupant's weight by the process described hereinabove with reference to FIGS. 1 through 10 without considering the seat belt tension. In the second step microprocessor of processing unit 36 computes the product of a factor times the seat belt tension measured by seat belt tension sensor 252 or 252P and subtracts that product from the aforementioned measurement of occupant weight. A suitable factor might be, as explained in detail hereinabove, two times the cosine of the angle of the seat belt from the vertical. If the shoulder belt is under tension then a different calculation is required as explained in detail hereinabove. The exact value of the factor is determined by analyzing the design of the seat belt and/or performing experiments to determine the relationship between seat belt tension and the effect of seat belt tension and other factors on the relation between measured weight and the actual occupant weight. In the case of the example of multiplying the seat belt tension by two times the cosine of the angle of the seat belt from the vertical, the product is subtracted from the measured weight and the difference is the final weight determination. Other processes for determining seat occupant weight will now be evident to those skilled in the relevant arts.

Proceeding now with particular reference to FIG. 13, seat belt tension sensor 252P resembles seat belt tension sensor 252 illustrated in FIGS. 11 and 12 but is different in that force sensor 30″ comprising a fluid filled bellows sided bottle and a pressure sensor replaces the combination of permanent magnet 286 and magnetic field sensor 292, and an outer cover 280 is included. All components of seat belt tension sensor 252P illustrated in FIG. 13 that are or may be the same as the corresponding components of seat belt tension sensor 252 are identified by the same numbers as are used in FIGS. 11 and 12. Seat belt tension sensor 252P comprises two bowed bands 264″ and 266″ joined at their lower ends by loop 268″. Bands 264″ and 266″ are joined at their upper ends by rivet 272″ to extension 274″ of seat belt latch 276 and to outer cover 280. Loop 268″ attaches bands 264″ and 266″ to anchor 278. Force sensor 30″ is located where it is squeezed between bands 264″ and 266″. Anchor 278 is attached to seat 10 by stud 296 and nut 298. In other applications anchor 278 may be attached to the vehicle structure instead of being attached to a seat such as seat 10. Force sensor 30″ may be replaced by any other force sensor known to be suitable by those skilled in the relevant arts.

Bands 264″ and 266″ are preferably unitary with loop 268″ and formed of a strip of a material such as spring steel. However, the designer can select any material that offers sufficient strength and resiliency. Extension 274″ extends between seat belt latch 276 and bands 264″ and 266″. Seat belt latch 276 and anchor 278 are or may be the same as the corresponding components of seat belt tension sensor 252 and the reader is referred to the descriptions of those components given hereinabove with reference to FIGS. 11 and 12 for their description. Rivet 272″ is longer than rivet 272 for extending beyond cover 280. Outer cover 280 is preferably a sleeve of rectangular cross section adapted for rigid attachment by rivet 272″ to bands 264″ and 266″ and extension 274″. Outer cover 280 slidably engages loop 268″. A preferred material for outer cover 280 is mild steel.

The materials and methods referred to hereinabove are only suggestions and other materials and methods may be substituted by those skilled in the relevant arts.

The operation of the seat belt tension sensor 252P of the invention will now be described with particular reference to FIG. 13. When tension 276F in the seat belt is applied to seat belt latch 276 the tension is transferred to extension 274″, which applies the tension through rivet 272″ to bands 264″ and 266″. The tension in bands 264″ and 266″ causes them to attempt to straighten. As they attempt to straighten, bands 264″ and 266″ attempt to compress force sensor 30″ or other force sensor; causing it to transmit a signal through cable 262′ indicating the applied force. The applied force is proportional to the tension in the seat belt. Therefore, the force signal from force sensor 30″ or other force sensor indicates the tension in the seat belt.

The seat belt may apply a lateral force indicated by arrow 276L in addition to force indicated by arrow 276F. This can happen if free rotation of seat belt tension sensor 252P at loop 268″ is limited by an obstacle such as a part of a seat. The lateral force applies a torque to seat belt latch 276 and to extension 274″. Without outer cover 280 being rigidly affixed to extension 274″ by rivet 272″, the torque would distort bands 264″ and 266″ and make the seat belt tension readings depend on both the tension and the angle at which the tension is applied to latch 276.

Outer cover 280 prevents the aforementioned distortion by transferring the torque to loop 268″ thorough the contact between outer cover 280 and loop 268″ thereby preventing the torque from being applied to bands 264″ and 266″ at rivet 272″. Outer cover 280 also operates to protect bands 264″ and 266″ from externally applied forces, which might be caused by lateral force urging seat belt tension sensor 252P to rotate at loop 268″ until band 264″ or 266″ contacted an obstacle such a part of a seat.

The designs, materials and methods referred to hereinabove are only suggestions and other designs, materials and methods may be substituted by those skilled in the relevant arts.

Proceeding now with particular reference to FIG. 14, load cell 300 comprises a force sensor 310, a base 312, a retainer 330, a force transmitter 340, and springs 362 and 382.

Force sensor 310 comprises bellows sided bottle 320 filled with liquid 198, pressure sensor 230, stopper and electrically insulating feedthrough 244, electrical conductors 246, electrical cable 248 and clamping ring 127″. Bottle 320 comprises bottle base 322, bellows shaped sides 324, bottle shoulder 326 and neck 328. Pressure sensor 230 of force sensor 310 provides an electrical signal through conductors 246 and electrical cable 248 to a processing unit such as processing unit 36. Other force sensors known to be suitable by those skilled in the relevant arts may be substituted for force sensor 310.

Base 312 comprises a threaded stud 314 and a flat circular disk 316 having threads 318 on its outer periphery. Base 312 is preferably made of steel for strength and low cost. Threaded stud 314 engages the threads of a threaded fastener such as a nut for retaining load cell 300 during large upward forces, which might result from a collision of the vehicle. Alternately, threaded stud 314 may be attached to a threaded fastener unitary with the floor of the vehicle. In a typical current production design, threaded fasteners are welded to the horizontal part of a “U” shaped beam that is then inverted and welded to the vehicle floor.

Retainer 330 comprises flange 332, a cylindrical extension 334 and surfaces 336 and 338 for attachment to springs 362 and 382. Cylindrical extension 334 has threads 339 on its inside diameter for engaging threads 318. Retainer 330 is preferably made of the same steel as base 312 for compatibility and low cost.

Force transmitter 340 comprises threaded neck 342, force applicator 344 incorporating stop 346 and abutment 348, ledge 352, and two surfaces 354 and 356 for attachment to springs 362 and 382. Force transmitter 340 receives force from a seat flange 218 at ledge 352 and also receives force from springs 362 and 382 at surfaces 354 and 356 and transmits the total force received to force sensor 310. Force transmitter 340 is preferably made of the same steel as base 312.

Upper spring 362 comprises a washer shaped base 364, outer flange 366 ending at surface 368 and inner flange 372 ending at surface 374. Lower spring 382 comprises a washer shaped base 384, outer flange 386 ending at surface 388 and inner flange 392 ending at surface 394. Spring 362 and 382 are each preferably formed of a spring steel into the form of the surface of half a torus of rectangular cross section. A preferred spring steel is Martinsite 190 supplied by Ispat-Inland Steel Company because it can be formed in its hardened state and does not require heat-treating. Alternately, springs 362 and 382 may be formed from spring steel in its annealed condition and heat-treated. If springs 362 and 382 are to be laser or projection welded to low carbon steel, 17-7 stainless steel and Martinsite 190 are preferred steels. 17-7 stainless steel is preferably formed in its annealed state followed by heat-treating. After forming and, if required, heat-treating; washer shaped bases 364 and 384 of springs 362 and 382 respectively are stressed into retaining a shallow conical shape resembling a Belleville spring. For best resistance to radial forces the conical height is set so bases 364 and 384 are flat when stressed for providing preload force in the completed load cell.

The output of load cell 300 will be independent of temperature if the thermal expansion of force sensor 310 matches the thermal expansion of the metal parts of load cell 300. This is not possible if force sensor 310 comprises bellows sided bottle 320 filled with a suitable fluid. However, disk shaped force sensors having very little thermal expansion are commercially available from Kavlico Corporation of Moorepark, Calif. and others. One of these force sensors may be placed against a disk of a higher thermal expansion material such as aluminum to achieve a combined thermal expansion that matches the thermal expansion of the steel parts of load cell 300 to achieve a first preferred design for load cell 300 that produces an output signal that is independent of temperature.

A second preferred design that makes the output of load cell 300 independent of temperature, particularly when force sensor 310 is bellows sided bottle 320 filled with fluid, is a design in which springs 362 and 382 are constant force springs when their bases 364 and 384 are stressed to flatness by preloading. For springs 362 and 382 to operate as constant force springs the conical height must be set to a height that causes washer shaped bases 364 and 384 to operate, when compressed to be flat, as Belleville springs with a negative spring constant. The negative spring constant must be equal and opposite to the spring constant contributed by flexing at the junctures between the washer shaped bases 364 and 384 and the inner and outer flanges. The exact dimensions to meet this requirement may be determined by experiment or by calculations or by using finite element analysis software. Achieving constant force over a range of spring deflections is likely to require bases 362 and 382 to have a conical height to material thickness ratio of two to three. Alternately, the material at the juncture of bases 362 and 382 and the inner and outer flanges may be thinned (not illustrated) by a process such as grinding to reduce the contribution to the spring constant from flexing at the junctures, which would enable the conical height to material thickness ratio to be smaller. For a particular application the preferred process would be selected to minimize the manufacturing cost or to meet the required specifications.

Alternately, a design may be selected wherein the output from force sensor 310 varies with temperature and compensation for the variation with temperature is provided by such as an ASIC in load cell 300 or by adapting processing unit 36 to compensate for temperature.

A preferred method of manufacturing load cell 300 is summarized in this paragraph and described in detail in the following paragraphs: The retainer 330, force transmitter 340, and springs 362 and 382 are joined into an assembly. The force sensor 310 is then inserted into the assembly and base 312 is installed followed by welding or other process to make the position of base 312 permanent.

Firstly, surface 394 of lower spring 382 is joined to surface 356 of force transmitter 340, preferably by friction welding or by laser welding.

Secondly, surface 388 of lower spring 382 in the assembly comprising lower spring 382 and force transmitter 340 is joined to surface 338 of retainer 330 by friction welding. The parts of the assembly of lower spring 382 and force transmitter 340 are supported by a fixture during this welding process to minimize the stress on lower spring 382 from forces applied during welding.

Thirdly, upper spring 362 is joined to the assembly of force transmitter 340, lower spring 382 and retainer 330 by friction welding surface 374 of inner flange 372 of upper spring 362 to surface 354 of force transmitter 340 while simultaneously welding surface 336 of retainer 330 to surface 368 of outer flange 366 of upper spring 362. Upper spring 362, force transmitter 340 and retainer 330 are supported by a fixture during this welding process to insure correct relative positioning after the weld is complete.

Since surfaces 354 and 374 are compressed together by the preload force of spring 362, welding is not required for normal operation of load cell 300 and it may be tempting to omit the welding. However, omitting the welding allows surfaces 354 and 374 to move relative to each other or to separate under radial stresses or moments, which might make the output of load cell 300 more responsive to side forces and moments than is desired.

Finally, force sensor 310 is placed in the completed assembly of retainer 330, force transmitter 340, and springs 362 and 382 as illustrated in FIG. 14. Base 312 is placed so its threads 318 engage threads 339 of retainer 330. While the output of force sensor 310 is monitored base 312 is tightened until the output of force sensor 310 indicates springs 362 and 382 are applying a predetermined preload force to force sensor 310. When the predetermined force is achieved, base 312 is permanently locked to retainer 330 by any of many suitable means known to those skilled in manufacturing. Applying adhesive to the threads is one known way to lock a threaded joint. Welding or indenting threads are other known means for keeping threaded fastenings from loosening or tightening over time. A particularly preferred process is to form a weld around the circumference of base 312, which has the advantage of sealing the interior against fluid penetration at threads 318.

The materials and methods and methods referred to hereinabove are only suggestions and other materials and methods may be substituted by those skilled in the relevant arts.

A preferred method of operation of the load cell 300 will now be described with particular reference to FIGS. 1, 2 and 14.

When force is applied to load cell 300, force applicator 344 of force transmitter 340 applies that force plus the preload force of springs 362 and 382 to force sensor 310. If force sensor 310 comprises a bellows sided bottle 320 filled with fluid 198 the applied force further pressurizes liquid 198. The increase in pressure in liquid 198 is sensed by pressure sensor 230 and is proportional to the total force applied to force sensor 310 whereby the output of pressure sensor 230 indicates the total force applied to load cell 300. If force sensor 310 is of another design such as the aforementioned force sensor made by Kavlico, then the change in the output of that force sensor indicates the total force applied to force sensor 230. Therefore, the electrical signal from load cell 300 indicates the total force applied to load cell 300.

When seat 10 is occupied, force from the weight of the seat and the occupant is received through seat frame member 22 and flange 218. Flange 218 transmits the force it receives to the ledge 352 of force transmitter 340, which transmits the force to force sensor 310. The force applied to force sensor 310 causes pressure in liquid 198, which is sensed by pressure sensor 230 and communicated to a processing unit such as processing unit 36. The microprocessor of the processing unit may adjust the pressure for the actual atmospheric pressure and for the actual ambient temperature. If force sensor 310 is of another design such as the aforementioned force sensor made by Kavlico, then that force sensor senses the force applied to force sensor 310 and transmits a signal indicating that force to a processing unit such as processing unit 36.

The processing unit multiplies the signal received from force sensor 310 by a factor that converts the signal received from force sensor 310 to the force being received by force sensor 310 in desired measurement units. The processing unit then subtracts a force reading taken at a time when the seat was empty to determine the force being contributed by the seat occupant. The sum of the forces from all of the load cells is added to calculate the weight being applied by the seat occupant to the seat. The processing unit may also correct the signal for variations in temperature and atmospheric pressure. The processing unit may also average the signal over a period of time such as several seconds to filter out effects of vibrations of the vehicle and movement of the seat occupant.

The materials and methods referred to hereinabove are only suggestions and other materials and methods may be substituted by those skilled in the relevant arts.

Although the description of this invention has been given with reference to particular embodiments, it is not to be construed in a limiting sense. Many variations and modifications will now occur to those skilled in the art. For a definition of the invention reference is made to the appended claims.

1. A load cell having an axis, and comprising:
two force input members for receiving force applied to said load cell,
a first spring and a second spring, and
force sensing means responsive to said force applied to said load cell by producing a force signal, and wherein:
each said spring comprises: a first part linked with one of said force input members for movement therewith, a second part linked with the other of said force input members for movement therewith and a uniting part unitary with said first and second parts, and
said uniting parts are offset from each other in the direction of said axis, whereby
said force signal indicates the axial component of said force applied to said load cell and is insensitive to components of said force applied to said load cell having directions perpendicular to said axis.

2. The invention as defined by claim 1, and wherein:
said force sensing means comprises a force sensor adapted for receiving force from said force input members, and
said force sensor is adapted to produce a force sensor signal responsive to said received force, whereby
said force sensor signal is said force signal.

3. The invention as defined by claim 1, and wherein said force sensing means comprises:
liquid pressurized by said force applied to said load cell, and
a pressure sensor responsive to said pressure in said liquid by producing a pressure signal, whereby
said pressure signal is said force signal.

4. The invention as defined by claim 3, and wherein said liquid has a larger thermal expansion coefficient than the thermal expansion coefficients of the materials of which said force input members and said springs are made, and
a said part of a said spring linked with a said force input member is linked by a link comprising a material having a larger thermal expansion coefficient than the thermal expansion coefficient of at least one of the materials of which said force input members and said springs are made, whereby
the variation of said force signal with temperature is controlled.

5. The invention as defined by claim 4, and wherein said link comprising a material having a larger thermal expansion coefficient comprises a sleeve.

6. The invention as defined by claim 1, and wherein:
a said spring when no force is applied thereto has the shape of a slightly conical washer unitary with two cylindrical flanges.

7. The invention as defined by claim 6, and wherein:
said spring that has the shape of a slightly conical washer unitary with two cylindrical flanges when no force is applied thereto is adapted to assume the shape of a flat washer unitary with two cylindrical flanges after it is preloaded during load cell manufacture.

8. The invention as defined by claim 1, and wherein:
said first spring comprises: (1) a first inner cylindrical flange, (2) a first outer cylindrical flange, and (3) a first uniting part; and
one of said first flanges is linked with one of said force input members for movement therewith and the other of said first flanges is linked with the other of said force input members for movement therewith, whereby
said one of said first flanges is a said first part and said other of said first flanges is a said second part.

9. The invention as defined by claim 8, and wherein:
said second spring comprises: (1) a second inner cylindrical flange, (2) a second outer cylindrical flange, and (3) a second uniting part; and
one of said second flanges is linked with one of said force input members for movement therewith and the other of said second flanges is linked with the other of said force input members for movement therewith, whereby
said one of said second flanges is a said first part and said other of said second flanges is a said second part.

10. The invention as defined by claim 1, and wherein
said springs exert a spring force between said force input members in a first direction that causes said force signal to indicate a greater force than if said spring force were zero, whereby
force applied between said force input members in the direction opposite said first direction causes said force signal to indicate a lesser force than said force signal indicates when said force applied to said load cell is zero.

11. A seat occupant weight sensing system comprising: (1) a seat, (2) a load cell, and (3) a processing unit for reckoning weight applied to said seat; and wherein:
said seat is adapted for receiving force from an occupant of said seat and applying force derived from said received force to said load cell,
said load cell comprises: (1) two force input members for receiving force applied to said load cell, (2) a spring, and (3) force sensing means for producing a force signal;
said spring comprises: (1) an outer cylindrical flange linked with one of said force input members for movement therewith, (2) an inner cylindrical flange linked with the other of said force input members for movement therewith, and (3) a uniting component unitary with said flanges; and wherein
said force signal is responsive to said force applied to said load cell,
and said processing unit is adapted to consider said force signal when said reckoning weight applied to said seat.

12. The invention as defined by claim 11, and wherein said processing unit is adapted to categorize the occupant of said seat in accordance with said force signal.

13. The invention as defined by claim 11, and wherein:
said force sensing means comprises: liquid pressurized by said force applied to said load cell and an absolute pressure sensor responsive to said pressure in said liquid by producing said force signal, and
said processing unit comprises: an atmospheric pressure sensor for measuring atmospheric pressure and means for correcting said force signal in accordance with said atmospheric pressure to obtain a corrected force signal,
whereby said corrected force signal indicates the component of the force applied to said load cell having the direction of an axis.

14. The invention as defined by claim 11, and including:
occupant protection means for protecting an occupant of said seat, said occupant protection means including a microprocessor, and
a seat belt and a seat belt tension sensor responsive to tension in said seat belt by providing a tension signal to said microprocessor, and wherein
said occupant protection means is adapted to be responsive to said tension signal when said protecting said occupant.

15. The invention as defined by claim 11, and wherein said load cell is tested after it is manufactured and numbers derived from the results of said tests are stored in said load cell.

16. The invention as defined by claim 15, and wherein said numbers are stored as markings on the outside of said load cell.

17. The invention as defined by claim 11, and including
attachment means for attaching said load cell to a structural member of said seat, and wherein
said load cell has an axis, and
said attachment means is adapted to prevent movement of said structural member relative to said load cell in a direction parallel to said axis and to permit limited movement of said structural member relative to said load cell in a direction perpendicular to said axis.

18. The invention as defined by claim 17, and wherein
said limited movement is achieved by providing an opening in said structural member sized to allow said limited movement therewithin by an element fixed with respect to said load cell.

19. The invention as defined by claim 11, and wherein a said link linking a said flange with a said force input member comprises a material having a larger coefficient of thermal expansion than at least one of the materials of which said force input members and said springs are made; whereby
the variation of said force signal with temperature is controlled.

20. The invention as defined by claim 11 and wherein:
a said force input member comprises threads for engaging a threaded fastening component, and including
a cover isolating material near said threads from said liquid; whereby
said force signal is less affected by tightness of said threaded fastening component.

21. A method of making a load cell comprising a spring and a force input member, the method comprising:
(1) pressing a surface of said spring against a surface of said force input member, while (2) performing a weld fixing the position of said spring relative to said force input member, (3) stressing said spring to form a gap between said surfaces, (4) injecting an accurately controlled amount of said liquid through an opening into said gap, and (5) sealing said opening; whereby
the effects of temperature on the performance of said load cell are accurately controlled.

22. A load cell having an axis, and comprising:
force input members for receiving force applied to said load cell, a spring, a link linking said spring to a said force input member, and force sensing means responsive to said force applied to said load cell by producing a force signal, and wherein:
said spring comprises: a first part linked by said link with one of said force input members for movement therewith, a second part linked with another of said force input members for movement therewith, and a uniting part unitary with said first and second parts; and wherein
said link is made of material having a larger thermal expansion coefficient than the thermal expansion coefficient of the material of which said spring is made, whereby
the variation of said force signal with temperature is controlled.
